(19) United States
(12) Patent Application Publication
(10) Pub. No.: US 2026/0370480 A1
(43) Pub. Date: Nov. 19, 2026

(54) TRUSTLESS ZERO-KNOWLEDGE RANDOMIZATION AND DISTRIBUTION SYSTEMS, METHODS, AND DEVICES

(71) Applicant: Ava Labs, Inc., New York, NY (US)

(72) Inventor: Sarp Taylan Tomruk, Kadikoy/Istanbul (TR)

(21) Appl. No.: 19/675,112

(22) Filed: May 12, 2026

Related U.S. Application Data
(60) Provisional application No. 63/805,139, filed on May 13, 2025.

(51) Int. Cl. H04L 9/32; H04L 9/08; H04L 9/30

(52) U.S. Cl. CPC H04L 9/3218; H04L 9/0825; H04L 9/30

(57) ABSTRACT

A system and method for trustless randomization and distribution on a distributed ledger. A smart contract deployed on a blockchain platform stores references to a public key, enforces a deterministic turn order for shuffling operations, and verifies zero-knowledge proofs. Off-chain components executing on computing devices of participants generate private keys, derive public keys, and perform shuffling operations comprising acquiring encrypted data, applying random permutations, applying re-encryption, and generating zero-knowledge proofs demonstrating valid permutation and re-encryption. The smart contract verifies each proof and updates stored data references upon successful verification.

### PRIORITY

This application claims priority to U.S. Application No. 63/805,139, titled TRUSTLESS ZERO-KNOWLEDGE RANDOMIZATION AND DISTRIBUTION SYSTEMS, METHODS, AND DEVICES, filed May 13, 2025, which is hereby incorporated by reference in its entirety.

Any and all applications for which a foreign or domestic priority claim is identified in the Application Data Sheet as filed with the present application are hereby incorporated by reference under 37 C.F.R. § 1.57.

### BACKGROUND

Cryptographic systems have long been utilized to secure sensitive information and enable secure communication between parties. These systems employ various mathematical algorithms and protocols to encrypt data, verify authenticity, and maintain confidentiality. As technology has advanced, cryptographic techniques have evolved to address increasingly complex security challenges across diverse applications.

In recent years, blockchain technology has emerged as a prominent platform leveraging cryptographic principles to create decentralized and tamper-resistant ledgers. Blockchain systems typically incorporate cryptographic hash functions, digital signatures, and consensus mechanisms to ensure data integrity and facilitate trustless interactions between participants. The integration of advanced cryptographic methods within blockchain frameworks continues to be an active area of research and development aimed at enhancing security, privacy, and efficiency in distributed systems.

Many applications built on blockchain platforms involve randomization processes, such as gaming, lotteries, secure voting, and confidential data distribution. Conventional approaches to on-chain randomization often rely on “provably fair” seeds, commit-reveal sequences, or centralized random oracles to generate random outcomes. However, these approaches may present challenges related to trust, as participants may have concerns about whether a single entity or oracle can influence, predict, or manipulate the random outcomes. Additionally, processing all information on-chain typically results in complete transparency, which may be undesirable in applications where selective information disclosure is desired—for example, in card games where certain cards are to remain hidden from specific players until appropriate moments.

Zero-knowledge cryptographic techniques offer potential approaches for verifiable yet privacy-preserving operations, allowing data to be processed and validated without revealing underlying secrets. However, implementing such techniques in decentralized environments while balancing on-chain verification costs, computational efficiency, and multi-party participation presents ongoing challenges. Therefore, improved systems and methods that address at least one or more of these considerations in the art are desired.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a system for trustless randomization and distribution on a distributed ledger is provided. The system comprises one or more on-chain components comprising a smart contract deployed on a blockchain platform. The smart contract is configured to store one or more references to a public key, enforce a deterministic turn order for shuffling operations to be completed by a plurality of participants, and verify one or more zero-knowledge proofs generated by the plurality of participants. The system further comprises one or more off-chain components executing on computing devices of the plurality of participants. The one or more off-chain components are configured to generate a private key on a computing device of one participant of the plurality of participants, derive the public key from the private key, and register the public key with the smart contract. The one or more off-chain components are further configured to perform a shuffling operation comprising acquiring encrypted data from the smart contract, applying a random permutation to the encrypted data, applying re-encryption to the permuted data to produce updated encrypted data, and generating a zero-knowledge proof demonstrating that the updated encrypted data represents a valid permutation and re-encryption of the acquired encrypted data. The one or more off-chain components are further configured to submit the updated encrypted data and the zero-knowledge proof to the smart contract, wherein the smart contract verifies the zero-knowledge proof and updates stored data references upon successful verification.

According to other aspects of the present disclosure, the system may include one or more of the following features. The smart contract may be further configured to compute an aggregated public key from individual public keys of the plurality of participants, and the encrypted data may be encrypted under the aggregated public key. The shuffling operation may be performed sequentially by each participant of the plurality of participants such that the updated encrypted data reflects combined randomness contributions from the plurality of participants. The zero-knowledge proof may demonstrate that the shuffling operation applied a valid permutation to the encrypted data without revealing the permutation applied or encryption keys used. The one or more off-chain components may be further configured to perform partial decryption operations, wherein each participant of the plurality of participants removes an encryption layer corresponding to encryption applied by that participant during the shuffling operation. The partial decryption operations may be performed sequentially by the plurality of participants, and a last participant in a decryption sequence may obtain plaintext data. When the plaintext data is to be publicly revealed, the last participant may submit the plaintext data along with a consistency proof demonstrating that the plaintext data corresponds to ciphertext previously recorded by the smart contract. The smart contract may be configured to enforce a per-turn timeout mechanism and to forfeit a security deposit of a participant that fails to act within a timeout period. The smart contract may be configured to gate partial-decryption transactions on a predicate comprising at least one of a game-state phase condition, a wall-clock time condition, or an external oracle signal.

According to another aspect of the present disclosure, a method for trustless randomization and distribution on a distributed ledger is provided. The method comprises generating, by one or more off-chain components executing on a computing device of one participant of a plurality of participants, a private key. The method further comprises deriving a public key from the private key. The method further comprises registering the public key with a smart contract deployed on a blockchain platform, wherein the smart contract stores one or more references to the public key. The method further comprises performing, by each participant of the plurality of participants in a deterministic turn order enforced by the smart contract, a shuffling operation comprising acquiring encrypted data from the smart contract, applying a random permutation to the encrypted data, applying re-encryption to the permuted data to produce updated encrypted data, and generating a zero-knowledge proof demonstrating that the updated encrypted data represents a valid permutation and re-encryption of the acquired encrypted data. The method further comprises submitting the updated encrypted data and the zero-knowledge proof to the smart contract. The method further comprises verifying, by the smart contract, the zero-knowledge proof. The method further comprises updating, by the smart contract, stored data references upon successful verification of the zero-knowledge proof.

According to other aspects of the present disclosure, the method may include one or more of the following features. The method may further comprise computing, by the smart contract, an aggregated public key from individual public keys of the plurality of participants, wherein the encrypted data is encrypted under the aggregated public key. The method may further comprise performing partial decryption operations off-chain, wherein each participant of the plurality of participants removes an encryption layer from a data item in sequence, and obtaining, by a final participant in a decryption sequence, plaintext corresponding to the data item. The final participant may be a designated recipient of the plaintext, and the final participant may retain the plaintext without disclosing the plaintext to other participants. The method may further comprise generating, by the final participant, a consistency proof demonstrating that the plaintext data corresponds to ciphertext recorded on-chain, and submitting the plaintext data and the consistency proof to the smart contract for verification when the plaintext data is to be publicly revealed.

The foregoing general description of the illustrative embodiments and the following detailed description thereof are merely exemplary aspects of the teachings of this disclosure and are not restrictive.

### BRIEF DESCRIPTION OF THE DRAWINGS

Detailed descriptions of implementations of the present invention will be described and explained through the use of the accompanying drawings.

FIG. 1 depicts a system architecture diagram for a trustless zero-knowledge randomization and distribution system, according to some implementations herein.

FIG. 2 depicts a flowchart illustrating a method for trustless randomization and distribution, according to some implementations herein.

FIG. 3 depicts a protocol overview diagram for a trustless zero-knowledge randomization and distribution system, according to some implementations herein.

FIG. 4 depicts a sequence diagram illustrating a shuffle phase of a trustless randomization and distribution method, according to some implementations herein.

FIG. 5 is a block diagram of some implementations of a computing system according to some implementations herein.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

### Technical Problem in Distributed Ledger Randomization

Traditional distributed ledger systems and blockchain platforms may lack native sources of unbiased randomness. Existing approaches to on-chain randomness may generally fall into several categories, each presenting distinct technical characteristics and limitations. These approaches may include Verifiable Random Function (VRF) oracles, commit-reveal beacon schemes, threshold beacon systems, and Verifiable Delay Functions (VDFs).

VRF oracles may rely on a single key-holder or oracle committee to generate random values. VRF-based systems may provide cryptographic proofs that a random output was correctly computed from a given input and secret key, allowing participants to verify that a random value was computed correctly without the ability to predict the value before computation. However, VRF-based systems may centralize trust on the party holding the secret key. The party holding the secret key may have the ability to compute multiple outputs for different inputs and select an input that produces a favorable output. Additionally, VRF-based systems may not address selective disclosure requirements, as the random output may be visible to all participants once computed.

Commit-reveal beacon schemes, such as RANDAO, may distribute the randomization process among multiple participants. In a commit-reveal protocol, each participant may generate a secret value, compute a hash of the secret value, and publish the hash as a commitment. After all participants have published commitments, participants may reveal their secret values. The final random outcome may be computed by combining the revealed values, such as by computing an exclusive-or (XOR) operation or a hash of the concatenated values. Commit-reveal protocols may reduce reliance on a single party but may be susceptible to last-revealer manipulation. A participant who is the last to reveal may observe all other revealed values and compute the resulting outcome before deciding whether to reveal. If the computed outcome is unfavorable, the last-revealing participant may choose to withhold the reveal, causing the protocol to abort or default to an alternative outcome. This withholding behavior may allow a participant to bias outcomes by selectively aborting unfavorable rounds. Commit-reveal protocols may also be susceptible to front-running attacks in blockchain environments, where a participant may observe another participant's reveal transaction in a mempool and submit a transaction with a higher gas price to have the observing participant's reveal processed first.

In alternative platforms, threshold beacon systems may distribute trust across a validator set by requiring a threshold number of parties to cooperate in generating random values. Threshold-based systems may reduce the risk of a single party manipulating outcomes, but threshold-based systems may operate under honest-majority assumptions. If a sufficient number of threshold participants collude, the colluding participants may be able to bias or predict random outcomes. Threshold-based systems may also introduce coordination overhead among the threshold participants.

Verifiable Delay Functions (VDFs) may make outputs unbiasable through sequential computation requirements. VDFs may require a specified amount of sequential computation to produce an output, and the output may be verified more quickly than the output was computed. However, VDFs may produce a single public scalar per invocation. The computation of VDFs may be non-parallelizable, and VDF constructions may depend on external entropy seeds to provide input randomness.

Furthermore, each of these randomness generation approaches may deliver a single public random value per draw. However, many decentralized applications may require more than a single random scalar. This characteristic may limit the applicability of these approaches to applications that require more than a single random scalar, such as applications requiring trustless, verifiable permutation of structured collections with selective distribution to designated recipients. Card games, sealed-bid auctions, jury selection from registries, federated voting systems, and transaction ordering mechanisms may benefit from trustless, verifiable permutation of structured collections with selective distribution to designated recipients. Additionally, processing all information on-chain may result in complete transparency, where all data stored on the blockchain is visible to all participants. While transparency may be desirable in some applications, complete transparency may be undesirable in applications where selective information disclosure is desired. For example, in card games where certain cards are to remain hidden from specific players until appropriate moments, complete on-chain transparency may compromise the mechanics of such games. Similarly, in sealed-bid auctions where bid values are intended to remain confidential until a designated revelation time, complete transparency may allow participants to observe competitor bids before the auction closes.

For instance, in card games such as poker or blackjack, certain cards may be intended to remain hidden from specific players until appropriate moments during gameplay. A player's hand may be private to that player, while community cards may be revealed to all players at designated times. If all card data is visible on-chain to all participants, the mechanics of such games may be compromised, as players may be able to view cards that are intended to be hidden from the players. In sealed-bid auction applications, bid values may be intended to remain confidential until a designated revelation time. If bid values are visible to all participants before the auction closes, participants may be able to adjust bids based on observed competitor bids, undermining the sealed-bid mechanism. In jury selection or panel selection applications, a pool of candidates may be randomized and selected without any single party having the ability to influence which candidates are selected. The selection process may benefit from verifiable randomization that distributes trust among multiple participants rather than relying on a single randomization authority. In federated voting systems, ballot options may be presented in randomized order to voters to reduce position bias effects in voting outcomes. Individual votes may be intended to remain confidential while the aggregate result is made public. The randomization of ballot ordering and the confidentiality of individual votes may benefit from approaches that provide both verifiable randomization and selective information disclosure. In transaction ordering applications, the order in which transactions are processed within a batch may affect the outcomes of those transactions. Verifiable randomization of transaction ordering may reduce the ability of any single party to manipulate transaction ordering for advantage.

The applications described above, including card games, sealed-bid auctions, jury selection, federated voting systems, and transaction ordering, are illustrative examples and are not intended to be exhaustive. In some aspects, the systems and methods described herein may be applied to other applications that involve trustless randomization and selective distribution of data items. Such applications may include, without limitation, resource allocation systems, randomized assignment protocols, confidential data distribution mechanisms, fair ordering systems, or other contexts where multiple parties may benefit from verifiable randomization without reliance on a single trusted authority. The specific requirements for randomization, selective disclosure, and trust distribution may vary across different application domains, and the protocol structure may be adapted to address the particular requirements of each application.

In some implementations, these applications may share common requirements for trustless, verifiable permutation of structured collections, where the permutation is jointly determined by multiple participants and where specific items from the permuted collection may be selectively disclosed to designated recipients at designated times. Conventional randomness generation approaches that deliver a single public scalar per draw may not directly address these requirements.

Another method of randomness generation in distributed systems involves centralized random oracle services that may provide random values to smart contracts by fetching randomness from external sources and delivering the randomness on-chain. Random oracle services may utilize hardware random number generators, atmospheric noise, or other entropy sources to generate random values. However, centralized random oracle services may introduce a single point of trust into the randomization process. The oracle operator may have the ability to observe pending transactions and selectively delay or reorder the delivery of random values. The oracle operator may also have the ability to substitute random values before delivery. Even if the oracle operator acts honestly, participants may lack cryptographic proof that the random values were generated without manipulation. Additionally, centralized oracle services may present availability concerns, as the oracle service may become unavailable or may be subject to denial-of-service attacks.

Blockchain-based applications that involve randomization processes, such as gaming, lotteries, secure voting, and confidential data distribution, face technical challenges related to generating random outcomes in a trustless manner. Conventional approaches to on-chain randomization may rely on provably fair seeds, commit-reveal sequences, or centralized random oracles to generate random outcomes. These approaches may present challenges related to trust, as participants may have concerns about whether a single entity or oracle can influence, predict, or manipulate the random outcomes.

In systems that utilize provably fair seeds, a single party may generate or contribute a seed value that influences the random outcome. If that party withholds partial information or influences the seed generation process, the party may be able to bias or predict the resulting random values. Commit-reveal sequences may similarly be susceptible to manipulation, as a participant who commits a value may choose not to reveal the value if the participant determines that the outcome would be unfavorable, or a participant may attempt to front-run other participants' reveals to gain an advantage.

Centralized random oracles present additional trust considerations. A centralized oracle may serve as a single point of failure or a single point of trust in the randomization process. Participants may have concerns about whether the oracle operator can influence, predict, or selectively withhold random values. Even if the oracle operates honestly, participants may lack cryptographic assurance that the oracle has not been compromised or manipulated.

As noted above, in addition to trust considerations in randomization, blockchain systems may present challenges related to transparency. Processing all information on-chain typically results in complete transparency, where all data stored on the blockchain is visible to all participants. While transparency may be desirable in some applications, complete transparency may be undesirable in applications where selective information disclosure is desired. Accordingly, systems that process randomization and distribution on blockchain platforms may benefit from approaches that address both the trust considerations in randomization and the transparency considerations in information disclosure.

### Technical Solution Overview

A trustless zero-knowledge randomization and distribution system according to some implementations may employ a combination of on-chain and off-chain components to address the limitations of conventional randomness generation approaches. The system may enable concealment of specific information from certain participants while simultaneously randomizing the distribution of data to participants without relying on a central oracle.

In some implementations, the system may perform a method for multiple parties to jointly shuffle and distribute a collection of data items without any single party controlling the outcome. In some implementations, the collection may comprise playing cards in a card game, bid values in an auction, candidate identifiers in a selection process, or other data items that benefit from randomization and selective disclosure. The system may allow the parties to shuffle the collection in a manner where each party contributes randomness to the final ordering, and no party can predict or manipulate the result unless all other parties cooperate with that party. The shuffling process may be analogized to a physical card shuffling scenario where multiple people each shuffle a deck in turn. In a physical scenario, if each person shuffles the deck before passing it to the next person, the final ordering of the cards reflects the combined shuffling actions of all participants. Even if some participants attempt to arrange the cards in a particular order, an honest participant who shuffles randomly may disrupt any predetermined arrangement. The system may implement a digital equivalent of this process using cryptographic techniques that allow verification that each participant shuffled correctly without revealing how each participant shuffled.

In some implementations, the system may use encryption to hide the contents of data items while they are being shuffled. Each data item may be encrypted such that no single party can read the contents without cooperation from other parties. During shuffling, each participant may rearrange the encrypted items and add a layer of encryption. The added encryption may obscure the relationship between the input order and the output order of the items. After all participants have shuffled, the items may be in a randomized order that no single participant could have predicted or controlled.

After shuffling, the system may selectively reveal data items to designated recipients. For items intended for a specific recipient, the other participants may remove their encryption layers while leaving the recipient's encryption layer in place. The recipient may then decrypt the item privately. For items intended to be publicly revealed, all participants may remove their encryption layers, and the final decrypted value may be posted publicly along with a proof that the revealed value matches the encrypted value that was shuffled.

In some implementations, one or more on-chain components of the system may provide data storage, track participant actions, and verify cryptographic proofs. The on-chain components may comprise one or more smart contracts deployed on a blockchain platform. The smart contracts may store references to encrypted data, record participant registrations and public credentials, enforce turn ordering, and verify zero-knowledge proofs submitted by participants. The on-chain components may maintain a verifiable record of protocol state transitions that is visible to all participants.

In some implementations, one or more off-chain components of the system may handle encryption operations, shuffling operations, and decryption operations. Each participant may perform encryption and decryption operations locally on a computing device controlled by the participant. The off-chain components may generate zero-knowledge proofs demonstrating that operations were performed correctly. By performing computationally intensive operations off-chain, the system may reduce on-chain computational costs while maintaining verifiability through the submission of proof artifacts to the on-chain components.

In some implementations, each participant of a plurality of participants may generate a private key off-chain. The private key may remain under the control of the participant and may not be transmitted to other participants or recorded on-chain. Public credentials may be derived from the private key of each participant, and references to the public credentials may be stored by the on-chain components. The separation of private key generation and storage from on-chain operations may allow participants to contribute to the randomization process without exposing secret values.

During a shuffling phase, each participant may acquire encrypted data from the on-chain components, apply a random permutation to the encrypted data, apply encryption to the permuted data to produce updated encrypted data, and generate a zero-knowledge proof demonstrating that the shuffling operation was performed correctly. The participant may then submit the updated encrypted data and the zero-knowledge proof to the on-chain components for verification. In some implementations, the shuffling operation may be performed sequentially by each participant of the plurality of participants such that the updated encrypted data reflects combined randomness contributions from the plurality of participants. In some implementations, the zero-knowledge proofs may demonstrate that each shuffling operation applied a valid permutation to the encrypted data without revealing the permutation applied or encryption values used. The on-chain components may verify each zero-knowledge proof and update stored data references upon successful verification. Thus, no single party may reorder data in a hidden manner, as each shuffle or reveal may be verified through the posted zero-knowledge proof.

During a distribution phase, partial decryption operations may be performed off-chain by the participants. Each participant may remove an encryption layer corresponding to encryption applied by that participant during the shuffling operation. In some implementations, the partial decryption operations may be performed sequentially by the plurality of participants. A final participant in a decryption sequence may obtain plaintext data. When the plaintext data is to remain private to a designated recipient, the final participant may retain the plaintext data without disclosing the plaintext data to other participants. When the plaintext data is to be publicly revealed, the final participant may submit the plaintext data along with a consistency proof demonstrating that the plaintext data corresponds to ciphertext previously recorded by the on-chain components.

In some implementations, the system may achieve bias-resistance under a 1-of-n honesty assumption. Under this assumption, the joint permutation resulting from the sequential shuffling operations by n participants may be computationally indistinguishable from a uniformly random permutation if at least one participant of the n participants is honest. Each participant may contribute randomness to the joint permutation, and the contribution of an honest participant may prevent other participants from predicting or biasing the final permutation. The system may reduce the risk that a single entity can bias or predict random outcomes, as each participant contributes randomness validated by cryptographic proofs and no centralized random oracle is used.

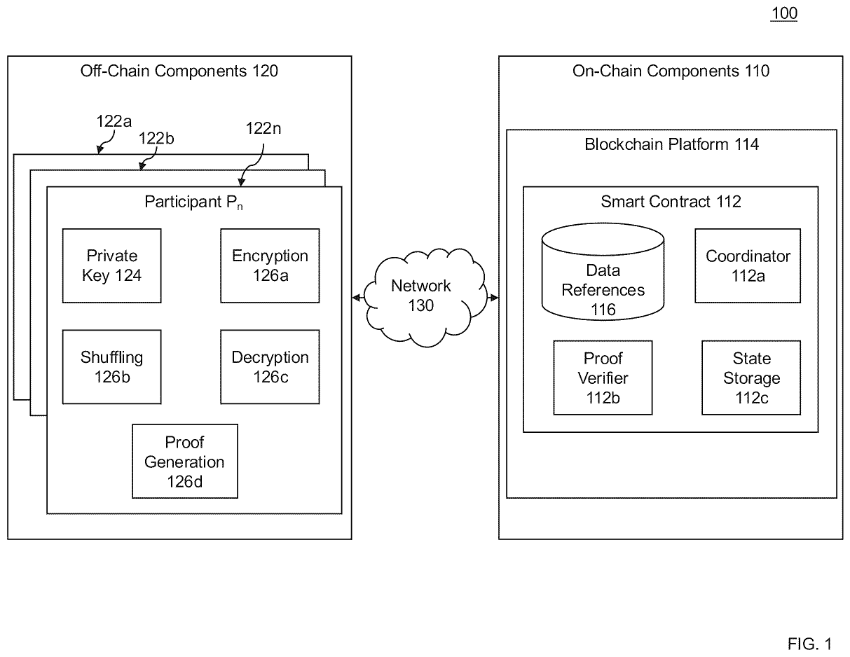

FIG. 1 depicts a system architecture diagram for a trustless zero-knowledge randomization and distribution system 100, according to aspects of the present disclosure. The system 100 may comprise one or more on-chain components 110 and one or more off-chain components 120. The on-chain components 110 and the off-chain components 120 may communicate via a network 130.

The on-chain components 110 may comprise a smart contract 112 deployed on a blockchain platform 114. The smart contract 112 may be configured to store data references 116, track participant actions, and verify cryptographic proofs. The data references 116 may comprise references to encrypted data items, participant public keys, and protocol state information. The blockchain platform 114 may comprise an Ethereum Virtual Machine (EVM) compatible blockchain or other smart contract platform.

The smart contract 112 may comprise a coordinator module 112a, a proof verifier module 112b, and a state storage module 112c. The coordinator module 112a may manage protocol phases, enforce turn ordering, and coordinate participant interactions. The proof verifier module 112b may verify zero-knowledge proofs submitted by participants, including shuffle proofs, decryption proofs, and reveal proofs. The state storage module 112c may store references to encrypted data states, participant registrations, and protocol phase indicators.

The off-chain components 120 may comprise a plurality of participant devices 122a, 122b, through 122n, corresponding to participants P₁, P₂, through Pₙ. Each participant device may comprise a computing device configured to perform encryption operations, shuffling operations, and decryption operations. Each participant device may store a private key 124 associated with the respective participant.

Each participant device may comprise an encryption module 126a, a shuffling module 126b, a decryption module 126c, and a proof generation module 126d. The encryption module 126a may perform ElGamal encryption operations using an aggregated public key. The shuffling module 126b may apply random permutations to encrypted data and apply re-encryption to permuted data. The decryption module 126c may perform partial decryption operations to remove encryption layers. The proof generation module 126d may generate zero-knowledge proofs demonstrating correct execution of shuffling and decryption operations.

The network 130 may comprise a communication network enabling the participant devices to communicate with the blockchain platform 114. The network 130 may comprise the Internet, a local area network, a wide area network, or a combination thereof. The participant devices may submit transactions to blockchain nodes on blockchain platform 114 via the network 130. The blockchain nodes may validate transactions and propagate transactions to the blockchain platform 114.

### Cryptographic Foundations—Elliptic Curve Encryption

This section describes example cryptographic building blocks used by the system to encrypt and shuffle data items. In some implementations, the system uses a type of encryption called ElGamal encryption, which allows data to be encrypted in a way that multiple parties can later cooperate to decrypt. In some implementations, the encryption operates on a mathematical structure called an elliptic curve, specifically a curve called BabyJubJub that is designed to work efficiently with zero-knowledge proof systems. Data items to be shuffled, such as playing cards or candidate identifiers, are first converted into points on this curve using a mapping function. Once encrypted, the data items can be re-randomized, meaning fresh randomness can be added to the encrypted data without changing the underlying value. This re-randomization capability allows participants to shuffle encrypted data in a way that hides the correspondence between the original order and the shuffled order, while still preserving the encrypted values for later decryption.

In some implementations, the trustless zero-knowledge randomization and distribution system may use ElGamal encryption on a BabyJubJub twisted Edwards curve. The BabyJubJub curve may be SNARK-friendly over a BN254 scalar field. In some implementations, the BabyJubJub curve may serve as an inner curve for Circom-Groth16 stacks on Ethereum Virtual Machine (EVM) compatible platforms. The BabyJubJub curve may define a prime-order subgroup, denoted [symbol] with a prime order [symbol] and a generator G∈ [symbol] . Group operations may be expressed using additive notation, where r·G denotes scalar multiplication of the generator G by a scalar r. The scalar field may be denoted [symbol] .

Items in a collection to be randomized may be mapped into the prime-order group [symbol] by an application-specific deterministic encoding function. The encoding function, denoted Enc₁ₜₑₘ, may map from an item space [symbol] to curve points in the prime-order group. The encoding function may be expressed as Enc₁ₜₑₘ: [symbol] → [symbol] . The image of the encoding function may consist of a set of predefined points corresponding to the items in the collection. For example, in a card game application, the encoding function may map each of 52 playing cards to a corresponding curve point. In a jury selection application, the encoding function may map each juror identifier in a registry to a corresponding curve point.

ElGamal encryption under an aggregated public key H may produce a ciphertext comprising a pair of group elements. The encryption of a message m with randomness r may be expressed as: (c₀, c₁)=(r·G, m+r·H) where c₀ and c₁ are the two components of the ciphertext, G is the generator of the prime-order group, and His the aggregated public key.

A re-randomization operation may add fresh randomness to an existing ciphertext without decrypting the ciphertext. The re-randomization operation may produce a new ciphertext that encrypts the same plaintext as the original ciphertext. Given a ciphertext (c₀, c₁) and fresh randomness r′ sampled from the scalar field [symbol] , the re-randomization operation may be expressed as: ReRand(c₀, c₁; r′)=(c₀+r′ ·G, c₁+r′ ·H). The re-randomization operation may add r′ ·G to the first ciphertext component and r′ ·H to the second ciphertext component. The resulting ciphertext may be indistinguishable from a fresh encryption of the same plaintext under the aggregated public key H. The re-randomization operation may be used during shuffling operations to obscure the relationship between input ciphertexts and output ciphertexts while preserving the encrypted plaintext values.

The cryptographic primitives described herein, including the BabyJubJub twisted Edwards curve and ElGamal encryption, are illustrative examples and are not intended to limit the scope of the disclosure. In some implementations, the trustless zero-knowledge randomization and distribution system may employ alternative elliptic curves, encryption schemes, or algebraic structures that provide comparable functionality.

In some aspects, the system may use alternative elliptic curves in place of the BabyJubJub curve. The alternative elliptic curves may include other twisted Edwards curves, Montgomery curves, short Weierstrass curves, or other curve forms that define prime-order subgroups suitable for cryptographic operations. The selection of an elliptic curve may depend on factors including compatibility with zero-knowledge proof systems, availability of precompiled contracts on target blockchain platforms, security level requirements, and computational efficiency considerations. Curves that are efficient within arithmetic circuits used by zero-knowledge proof systems may be preferred for implementations where on-chain proof verification is a deployment requirement.

In some aspects, the system may use alternative encryption schemes in place of ElGamal encryption. The alternative encryption schemes may include other additively homomorphic encryption schemes, partially homomorphic encryption schemes, or encryption schemes that support re-randomization operations. The encryption scheme may provide semantic security under appropriate hardness assumptions and may support the layered encryption and partial decryption operations used in the protocol. The selection of an encryption scheme may depend on factors including homomorphic properties, compatibility with zero-knowledge proof systems, ciphertext size, and computational efficiency.

In some implementations, the system may use algebraic structures other than elliptic curve groups. The alternative algebraic structures may include multiplicative groups of finite fields, class groups of imaginary quadratic fields, or other groups where the discrete logarithm problem is believed to be computationally hard. The protocol structure comprising key generation, aggregated public key computation, encryption, re-randomization, and layered partial decryption may be adapted to operate over alternative algebraic structures while preserving the security properties of the system.

The encoding function mapping items to group elements may be implemented using various techniques depending on the algebraic structure and application requirements. In some implementations, the encoding function may use hash-to-curve constructions that map arbitrary data to curve points. In some aspects, the encoding function may use deterministic pre-encoding that assigns predefined group elements to items in a collection. The encoding function may be injective such that distinct items map to distinct group elements, enabling unambiguous recovery of items from group elements during decryption operations.

### Zero-Knowledge Proof Systems

In some implementations, the system verifies that participants performed their operations (e.g., shuffling) correctly without revealing secret information. Zero-knowledge proofs allow a participant to prove that they shuffled data correctly without revealing how they shuffled it. In some implementations, the system uses a proof system called Groth16, which produces small proofs that can be verified quickly and cheaply on a blockchain. This section also describes example alternative proof systems that could be used with the same overall approach.

In some implementations, a trustless zero-knowledge randomization and distribution system may use Groth16 zero-knowledge proofs for verifying shuffle and decryption operations. Groth16 may be a zero-knowledge succinct non-interactive argument of knowledge (zk-SNARK) that produces constant-size proofs comprising three group elements. Groth16 may provide constant-time verification, where the verification time does not increase with the complexity of the statement being proven. The constant-size proofs and constant-time verification characteristics may reduce on-chain verification costs and enable efficient verification within smart contract execution environments.

In some implementations, a Groth16 prover may produce a proof w demonstrating that a statement (x, w)∈R holds for a relation R, where x represents public inputs and w represents a private witness. A Groth16 verifier may accept or reject the proof based on the public inputs and the proof elements. The verification operation may be expressed as Verify(srs, R, x, π)∈{0, 1}, where srs denotes a structured reference string produced during a setup phase.

On-chain verification of Groth16 proofs on Ethereum Virtual Machine (EVM) compatible blockchain platforms may use alt-bn128 pairing precompiles. The alt-bn128 pairing precompiles may be specified in Ethereum Improvement Proposals EIP-196 and EIP-197. EIP-196 may define precompiled contracts for elliptic curve point addition and scalar multiplication on the alt-bn128 curve. EIP-197 may define a precompiled contract for elliptic curve pairing operations on the alt-bn128 curve. The pairing precompiles may enable efficient verification of pairing-based zero-knowledge proofs within smart contract execution, as the precompiled contracts may execute pairing operations at lower gas costs than equivalent operations implemented in smart contract bytecode.

In some implementations, the system may use Pedersen hashing or Poseidon hashing for committing to public inputs within zero-knowledge circuits. Pedersen hashing may comprise an algebraic hash function that operates over elliptic curve groups and may be efficient to compute within arithmetic circuits used by zero-knowledge proof systems. Poseidon hashing may comprise a hash function designed for efficiency within arithmetic circuits, using operations over prime fields that align with the field arithmetic of zero-knowledge proof systems. The hash function may commit to public inputs including ciphertext vectors and public keys, binding the proof to specific input values. The binding property of the commitment may prevent input-substitution attacks where an adversary attempts to associate a valid proof with different public inputs than those for which the proof was generated.

In some implementations, a shuffle circuit may check that a permutation matrix H is valid, that output ciphertexts correspond to re-randomized permutations of input ciphertexts, and that the public input commits to the input ciphertext vector, output ciphertext vector, and aggregated public key via Pedersen or Poseidon hashing. The circuit may verify these conditions without revealing the permutation matrix or the re-randomization values used during the shuffle operation.

In some implementations, alternative zero-knowledge proof systems may be used with adaptation of the protocol structure. In some implementations, PLONK may be used as an alternative proof system. PLONK may provide a universal and updatable structured reference string, where a single setup ceremony may support multiple circuits. In some implementations, Marlin may be used as an alternative proof system. Marlin may also provide a universal and updatable structured reference string. In some implementations, Halo2 may be used as an alternative proof system. Halo2 may provide recursive proof composition capabilities. In some implementations, STARK-based provers may be used as alternative proof systems. STARK-based provers may provide transparent setup without requiring a trusted ceremony, though STARK proofs may be larger than SNARK proofs. The protocol structure comprising sequential per-participant shuffle-and-re-encrypt operations, layered partial decryption, per-step zero-knowledge proofs, and on-chain verification may be preserved across different proof system selections. The selection of a particular proof system may involve trade-offs between proof size, verification gas costs, and setup ceremony requirements.

### Trusted Setup and Ceremony

In some implementations, a one-time setup process may be implemented before the system can be used. For example, the Groth16 proof system required above requires initial parameters that must be generated through a ceremony involving multiple participants. The ceremony is designed so that the resulting parameters are secure as long as at least one ceremony participant acted honestly and destroyed their secret contribution.

In some implementations, Groth16 zero-knowledge proofs may use a structured reference string (SRS) produced during a trusted setup phase. The trusted setup may follow a two-phase ceremony structure comprising a Phase 1 ceremony and a Phase 2 ceremony. The Phase 1 ceremony may be a Powers-of-Tau ceremony that generates universal parameters usable across multiple circuits. The Phase 2 ceremony may be a circuit-specific ceremony that produces parameters tailored to a particular circuit definition.

In the Phase 1 Powers-of-Tau ceremony, multiple participants may sequentially contribute randomness to generate the universal parameters. Each participant in the Phase 1 ceremony may sample secret random values, apply the secret random values to the accumulated parameters, and pass the updated parameters to a subsequent participant. The security of the Phase 1 ceremony may rely on at least one participant destroying the secret random values used during the contribution of that participant. If at least one participant in the Phase 1 ceremony is honest and destroys the secret random values, the resulting parameters may be secure for use in subsequent phases.

The Phase 2 ceremony may chain from the Phase 1 Powers-of-Tau ceremony and may produce a circuit-specific structured reference string. The Phase 2 ceremony may be contributed by independent participants who each add randomness specific to the circuit being deployed. The Phase 2 ceremony may bind the structured reference string to a particular circuit definition, such that the resulting parameters may be used to generate and verify proofs for that circuit. The Powers-of-Tau-to-the-People framework may be used to reduce the trust footprint of the ceremony by enabling broader participation in the contribution process.

In some implementations, the system may use Circom 2.1.9 for circuit compilation. Circom is domain-specific language for defining arithmetic circuits used in zero-knowledge proof systems. Circuits defined in Circom may be compiled to Rank-1 Constraint System (R1CS) representations. The R1CS representation may encode the constraints that a valid witness satisfies for a given circuit.

The system may use snarkjs to generate Groth16 verifier contracts from the structured reference string produced by the Phase 1 and Phase 2 ceremonies. The snarkjs tool may generate Solidity smart contract code that implements the Groth16 verification algorithm for a specific circuit. The generated verifier contracts may be deployed on Ethereum Virtual Machine (EVM) compatible blockchain platforms. The generated verifier contracts may use the alt-bn128 pairing precompiles specified in EIP-196 and EIP-197 to perform pairing operations during proof verification.

The Groth16 verifier generated by snarkjs may comprise a compact implementation of the verification algorithm. The verifier may accept a proof and public inputs and may return a Boolean value indicating whether the proof is valid for the given public inputs. The mechanical generation of the verifier from the structured reference string may reduce the risk of implementation errors in the verification logic. The generated verifier may be subjected to differential testing against off-chain reference implementations to verify correctness.

### Trust Model

In some implementations, a key property of the system is that the final shuffled ordering is unpredictable and unbiased as long as at least one participant is honest. This is called a 1-of-n honesty assumption, meaning that even if all but one participant collude, the single honest participant's contribution is enough to ensure fairness.

In some implementations, the trustless zero-knowledge randomization and distribution system may achieve bias-resistance under a 1-of-n honesty assumption. Under the 1-of-n honesty assumption, the joint permutation resulting from sequential shuffling operations by n participants may be computationally indistinguishable from a uniformly random permutation if at least one participant of the n participants is honest. Each participant may contribute randomness to the joint permutation through the shuffling operation performed by that participant. The contribution of an honest participant may prevent other participants from predicting or biasing the final permutation, as the honest participant's permutation and re-randomization values may remain unknown to other participants.

The security of the bias-resistance property may reduce to the Decisional Diffie-Hellman (DDH) assumption on the BabyJubJub curve. The DDH assumption may state that, given group elements G, a·G, b·G, and a fourth element that is either ab·G or a random group element, no probabilistic polynomial-time adversary may distinguish between the two cases with non-negligible advantage. Under the DDH assumption on the BabyJubJub curve, the re-randomization operation applied during each shuffling step may produce ciphertexts that are indistinguishable from fresh encryptions of the same plaintext values. The indistinguishability of re-randomized ciphertexts may prevent an adversary from correlating input ciphertexts with output ciphertexts across a shuffling step performed by an honest participant.

The IND-CPA (indistinguishability under chosen-plaintext attack) security of the ElGamal encryption scheme may also reduce to the DDH assumption on the BabyJubJub curve. IND-CPA security may provide that an adversary cannot distinguish between encryptions of two different plaintexts chosen by the adversary. The IND-CPA security of ElGamal encryption under the aggregated public key may provide that ciphertexts remain semantically secure against any adversary that has not corrupted all n participants. Prior to any partial-decryption operation, each ciphertext in the shuffled collection may be semantically secure under the DDH assumption.

The last participant to perform a shuffling operation may gain no advantage over other participants. By the time the last participant performs the shuffling operation, the encryption layers contributed by all preceding honest participants may have made each ciphertext computationally indistinguishable from a fresh encryption of the same item under the DDH assumption. The permutation choice of the last participant may be as uninformed as the permutation choice of the first participant, as the last participant may not be able to determine the correspondence between input ciphertexts and the underlying plaintext values.

The soundness of the protocol may reduce to the soundness of the Groth16 verifier and to the binding property of Pedersen-style commitments used within the zero-knowledge circuits. A soundness attack on the protocol may consist of an on-chain transcript that the smart contract accepts but for which the protocol semantics are violated. A violation of protocol semantics may include an accepted shuffle step that does not correspond to any valid permutation matrix and re-randomization vector, an accepted partial-decryption step that does not correspond to any secret key consistent with the registered public key of the participant, or an accepted reveal that does not correspond to any consistent layer chain of decryptions.

Each of these potential violations may reduce to forging a Groth16 proof for the corresponding relation. Under the Groth16 knowledge-soundness assumption with respect to the circuit-specific structured reference string produced by the Phase 2 ceremony, no probabilistic polynomial-time adversary may forge such a proof except with negligible probability. The knowledge-soundness property of Groth16 may provide that a valid proof implies the existence of a witness satisfying the circuit constraints.

The binding property of Pedersen-style commitments used within the zero-knowledge circuits may prevent input-substitution attacks. In an input-substitution attack, an adversary may attempt to associate a valid proof with different public inputs than those for which the proof was generated. The commitment to public inputs, including the input ciphertext vector, output ciphertext vector, and aggregated public key, may bind the proof to specific input values. The binding property may provide that an adversary cannot find two different sets of inputs that produce the same commitment value, except with negligible probability. The combination of Groth16 knowledge-soundness and commitment binding may provide that each accepted protocol step corresponds to a valid operation on the committed inputs.

### On-Chain Efficiency

In some implementations, the system minimizes the costs of operating on a blockchain. Blockchain operations are expensive because every node in the network must process them. However, the system uses data compression techniques to reduce storage costs and uses efficient proof verification to minimize computational costs. This section provides specific measurements of the resources required for different operations.

The trustless zero-knowledge randomization and distribution system may use a compressed point representation to reduce on-chain data storage and calldata requirements. Each curve point may be stored on-chain as a tuple (x, b, δ), where x is a field element representing the x-coordinate of the curve point, b∈{0,1} is a y-sign selector bit, and δ is a small auxiliary value used in a recovery relation. The y-coordinate may be recovered from the compressed representation using the relation y=b·δ+(1−b)·( [symbol] −δ), where [symbol] is the prime order of the group. The compressed point representation may reduce calldata and storage by approximately 50% relative to uncompressed (x,y) form, where both coordinates are stored in full. The storage reduction may be achieved at the cost of one additional in-circuit constraint per point recovery during zero-knowledge proof verification.

In some implementations, on-chain shuffle proof verification may consume approximately 500,000 gas per verification operation. The gas consumption for shuffle proof verification may be comparable to the gas cost of approximately 5-8 ERC-20 token transfer operations. On-chain shuffle proof verification may complete in less than 100 milliseconds, which may be well under one block time on blockchain platforms with typical block times. The constant-time verification characteristic of Groth16 proofs may provide that the verification gas cost and latency do not increase with the size of the collection being shuffled.

In some implementations, per-player actions may consume approximately 100,000 gas on-chain. Per-player actions may include deal operations, decrypt operations, and reveal operations. A deal operation may comprise a request by a participant to deal a data item from the shuffled collection. A decrypt operation may comprise a partial decryption submission by a participant to remove an encryption layer from a ciphertext. A reveal operation may comprise a submission of plaintext data along with a consistency proof demonstrating that the plaintext corresponds to ciphertext previously recorded on-chain. The gas consumption for per-player actions may be lower than the gas consumption for shuffle proof verification, as per-player actions may involve verification of simpler proof structures than the full shuffle proof.

### Computational Performance

In some implementations, shuffle proof generation may take approximately 15-25 seconds for a collection of 52 items on commodity hardware. In some implementations, the commodity hardware may comprise an Intel Core i7-10700K CPU and 32 GB RAM. The shuffle proof generation time may scale with the number of items in the collection being shuffled, as the zero-knowledge circuit may encode constraints for each item in the collection.

Single-card decryption proof generation may take approximately 0.8-1.2 seconds. The decryption proof generation time may be shorter than the shuffle proof generation time, as the decryption circuit may encode constraints for a single ciphertext rather than for an entire collection of ciphertexts. The decryption proof generation time may allow for interactive gameplay in card game applications, where participants may request decryption of individual cards during gameplay.

Key generation may take approximately 0.3 seconds per participant. Each participant may generate a private key by sampling a random scalar from the scalar field and computing the corresponding public key by scalar multiplication of the generator. Signature operations may take approximately 0.1 seconds. The signature operation time may allow participants to sign messages and transactions without introducing perceptible latency in interactive applications.

The working-set memory for proof generation may be approximately 2 GB. The working-set memory may comprise memory used to store the constraint system, witness values, and intermediate computation results during proof generation. The 2 GB working-set memory may allow proof generation to be performed on commodity computing devices without requiring specialized hardware or high-memory server configurations.

### Complexity Analysis and Scalability

In some implementations, the system's performance changes as the number of items in a collection increases. The time required to generate a shuffle proof grows with the square of the number of items, which limits the practical size of collections that can be shuffled. However, the time required to verify a proof remains constant regardless of collection size.

The computational complexity of the trustless zero-knowledge randomization and distribution system may vary between prover operations and verifier operations. The prover may have O(q²) complexity in the number of items q in the collection being shuffled. The O(q²) prover complexity may arise from the in-circuit permutation-matrix check, which may serve as the computational bottleneck during proof generation. The permutation-matrix check may verify that a permutation matrix Π∈{0,1}^{q×q} is valid, with one entry equal to 1 per row and one entry equal to 1 per column. The verification of the permutation matrix within the zero-knowledge circuit may involve constraints that scale quadratically with the number of items in the collection.

The verifier may have O(1) complexity due to the constant-size proof and constant-time verification characteristics of Groth16 zero-knowledge proofs. The verification gas cost and verification latency may not increase with the size of the collection being shuffled. The asymmetry between prover complexity and verifier complexity may allow on-chain verification to remain efficient regardless of collection size, while proof generation time may scale with the square of the number of items.

The practical maximum collection size may be 52 items in some implementations. For a collection of 52 items, shuffle proof generation may take approximately 15-25 seconds on commodity hardware. For larger collections, the O(q²) scaling may result in longer proof generation times. In some implementations, the practical maximum collection size may be extended to 253 items via a wider bitmap implementation. The wider bitmap implementation may increase the number of items that may be represented within the permutation-matrix encoding used by the zero-knowledge circuit. The extension to 253 items may enable applications requiring larger collections, such as jury selection from larger candidate pools or auctions with larger numbers of bid items.

In some implementations, a Chinese-Remainder-Theorem (CRT) extension may lift the per-ciphertext plaintext capacity beyond a single-field-element ceiling. The single-field-element ceiling may be imposed by the encoding of plaintexts as elements of the scalar field associated with the elliptic curve used for encryption. The CRT extension may decompose plaintexts into residues modulo coprime moduli. Each residue may be encrypted independently, and the zero-knowledge circuit may prove a joint permutation across the residue components. At reveal time, the plaintext may be reconstructed from the residues via the Chinese Remainder Theorem. The CRT extension may enable encryption of plaintexts that exceed the capacity of a single field element, expanding the range of data items that may be processed by the system.

### Decentralized Randomization

In some implementations, the system improves upon existing blockchain randomization approaches by eliminating the need for a trusted central party. Conventional systems often rely on a single oracle service or key-holder to provide random values, which creates a point of trust and potential manipulation. The system described herein distributes the randomization process among all participants, with each participant contributing randomness that is validated by cryptographic proofs.

The trustless zero-knowledge randomization and distribution system may provide improvements to distributed ledger technology by eliminating reliance on centralized random oracles and removing single-key trust assumptions. Conventional blockchain-based randomization systems may rely on centralized random oracle services to provide random values to smart contracts. Centralized random oracle services may introduce a single point of trust into the randomization process. The oracle operator may have the ability to observe pending transactions and selectively delay or reorder the delivery of random values. The oracle operator may also have the ability to substitute random values before delivery. Even if the oracle operator acts honestly, participants may lack cryptographic proof that the random values were generated without manipulation. Centralized oracle services may also present availability concerns, as the oracle service may become unavailable or may be subject to denial-of-service attacks.

The trustless zero-knowledge randomization and distribution system may eliminate the reliance on centralized random oracles by distributing the randomization process among the participants themselves. Each participant of a plurality of participants may contribute randomness to the randomization process through local encryption and shuffling operations. The randomness contribution of each participant may be validated by cryptographic proofs submitted to on-chain components. No centralized random oracle may be used to generate or provide random values. By distributing the randomization process among the participants, the system may remove the single point of trust associated with centralized oracle services and the associated concerns regarding oracle manipulation, selective withholding, or availability failures.

The system may also remove single-key trust assumptions present in conventional randomization approaches. Verifiable Random Function (VRF) oracles may rely on a single key-holder or oracle committee to generate random values. The party holding the secret key may have the ability to compute multiple outputs for different inputs and select an input that produces a favorable output. In systems that utilize provably fair seeds, a single party may generate or contribute a seed value that influences the random outcome. If that party withholds partial information or influences the seed generation process, the party may be able to bias or predict the resulting random values. The trustless zero-knowledge randomization and distribution system may eliminate single-key trust assumptions by distributing encryption authority among multiple participants. Each participant may generate a private key locally, and the private key may remain under the control of the participant. No single participant may hold a key that provides unilateral control over the randomization outcome.

Each participant may contribute randomness to the joint permutation through the shuffling operation performed by that participant. During a shuffling operation, a participant may acquire encrypted data from on-chain components, apply a random permutation to the encrypted data, apply encryption to the permuted data to produce updated encrypted data, and generate a zero-knowledge proof demonstrating that the shuffling operation was performed correctly. The random permutation may be generated using local entropy sources on a computing device of the participant. The encryption may be applied using keys generated locally by the participant. The combination of multiple participants each contributing randomness through local permutation and encryption operations may result in collective randomness that no single participant can control or predict.

The system may achieve bias-resistance under a 1-of-n honesty assumption. Under the 1-of-n honesty assumption, the joint permutation resulting from sequential shuffling operations by n participants may be computationally indistinguishable from a uniformly random permutation if at least one participant of the n participants is honest. The contribution of an honest participant may prevent other participants from predicting or biasing the final permutation, as the honest participant's permutation and re-randomization values may remain unknown to other participants. The bias-resistance property may reduce the risk that a single entity can bias or predict random outcomes, as each participant contributes randomness validated by cryptographic proofs.

Zero-knowledge proofs may provide cryptographic verification that each shuffling operation was performed correctly without revealing the permutation applied or the encryption keys used. Each participant may generate a zero-knowledge proof demonstrating that the participant applied a valid permutation to the encrypted data and re-encrypted the data according to protocol requirements. The zero-knowledge proof may be submitted to on-chain components for verification. On-chain verification logic may confirm that the zero-knowledge proof is valid, thereby confirming that the shuffling operation was performed correctly. The verification may occur without revealing the permutation applied by the participant, preserving the privacy of the shuffle method while providing cryptographic assurance of correctness.

The zero-knowledge proofs may confirm correct permutations and data integrity without revealing how the shuffle was performed or which keys were used. Participants may verify that each shuffling operation was performed correctly based on the cryptographic proofs, without gaining information about the specific permutation applied. Other participants may observe the input ciphertext state and the output ciphertext state recorded on-chain, but other participants may not be able to determine the mapping between input positions and output positions. The zero-knowledge proof may provide cryptographic assurance that the mapping represents a valid permutation without revealing the permutation itself.

The privacy properties of the shuffling process may extend to the encryption keys used during the operation. Ephemeral keys generated for the shuffling operation may remain stored locally on the participant's device and may not be transmitted to other participants or recorded on-chain. The zero-knowledge proof may demonstrate that valid encryption was applied without revealing the encryption keys. Other participants may verify that the shuffling operation was performed correctly based on the proof, while remaining unable to derive the encryption keys or reverse the encryption applied by the shuffling participant.

The on-chain components may verify each zero-knowledge proof and update stored data references upon successful verification. No single party may reorder data in a hidden manner, as each shuffle or reveal may be verified through the posted zero-knowledge proof. If the proof verification succeeds, the on-chain contract may update the stored data references to reflect the new encrypted data state. If the proof verification fails, the on-chain contract may reject the transaction, preventing invalid shuffling operations from being recorded on-chain. The combination of distributed randomness contributions and on-chain proof verification may provide cryptographic assurance that the randomization process was performed correctly without relying on trust in any single party.

### Selective Information Disclosure

In some implementations, the trustless zero-knowledge randomization and distribution system may provide selective information disclosure capabilities that address limitations of conventional blockchain transparency. Conventional blockchain systems may store data in a manner that is visible to all network participants. Processing all information on-chain may result in complete transparency, where all data stored on the blockchain is visible to all participants. While transparency may be desirable in some applications, complete transparency may be undesirable in applications where selective information disclosure is desired.

In applications such as card games, certain cards may be intended to remain hidden from specific players until appropriate moments during gameplay. A player's hand may be private to that player, while community cards may be revealed to all players at designated times. If all card data is visible on-chain to all participants, the mechanics of such games may be compromised, as players may be able to view cards that are intended to be hidden from the players. In sealed-bid auction applications, bid values may be intended to remain confidential until a designated revelation time. In secure voting systems, individual votes may be intended to remain confidential while the aggregate result is made public. In confidential business negotiations, certain terms or offers may be intended to remain private to specific parties.

The trustless zero-knowledge randomization and distribution system may enable concealment of specific information from certain participants while maintaining verifiability. Each participant may perform encryption and decryption operations locally on a computing device controlled by the participant. Proof artifacts and updated ciphertext references may be confirmed on-chain, while secrets such as ephemeral keys and final plaintext may remain invisible to other participants unless intentionally revealed through the protocol.

Ephemeral keys generated for encryption operations during the shuffling process may remain stored locally on each participant's device. The ephemeral keys may be generated locally by each participant and may not be transmitted to other participants or stored on-chain. The ephemeral keys may be used to encrypt data during shuffling operations, and the encrypted data may be posted on-chain without revealing the ephemeral keys used in the encryption. Other participants may observe the encrypted data on-chain but may not be able to derive the ephemeral keys or the plaintext data from the encrypted data. The zero-knowledge proof may demonstrate that valid encryption was applied without revealing the encryption keys. Other participants may verify that the shuffling operation was performed correctly based on the proof, while remaining unable to derive the encryption keys or reverse the encryption applied by the shuffling participant.

Final plaintext values may similarly remain invisible to participants who are not intended to receive the plaintext. During partial decryption phases, participants may remove encryption layers from data items in sequence. Each participant may remove the encryption layer corresponding to the encryption applied by that participant, without revealing the participant's private key or the intermediate decryption results to other participants. The partial decryption operations may be performed off-chain by individual participants. Each participant may receive the current ciphertext state, apply the partial decryption operation locally using the participant's private key, and transmit the resulting intermediate ciphertext to the next participant in the decryption sequence.

Participants who perform partial decryption operations earlier in the sequence may not have access to the final plaintext, as the data item may remain encrypted under the encryption layers of subsequent participants. The last participant in the decryption sequence may be the first participant to observe the fully decrypted plaintext. The final plaintext may be obtained by the participant who is intended to receive the data, while other participants may not have access to the final plaintext unless the receiving participant chooses to reveal the plaintext.

When the plaintext data is intended to remain private to a designated recipient, the final participant may retain the plaintext data without disclosing the plaintext data to other participants. The designated recipient may use the plaintext data for the purposes of the application without revealing the plaintext to other participants. In card game applications, a player who receives a dealt card may observe the card value while other players remain unable to determine the card value from the encrypted data recorded on-chain.

When the plaintext data is to be publicly revealed, the final participant may submit the plaintext data along with a consistency proof demonstrating that the plaintext data corresponds to ciphertext previously recorded by the on-chain components. The consistency proof may demonstrate that the plaintext corresponds to the correct decryption of the ciphertext that was recorded on-chain after the shuffling process. The on-chain contract may verify the proof before accepting the revealed plaintext, confirming that the final participant has not substituted a different plaintext value. The public verifiability of the consistency proof may provide transparency regarding the correctness of the reveal operation while maintaining the privacy of data items that are not intended to be revealed.

The combination of zero-knowledge proof verification and selective key management may enable the system to provide verifiable randomness while preserving privacy. Participants may verify that each shuffling operation was performed correctly based on the zero-knowledge proofs, providing assurance that the randomization process was not manipulated. At the same time, participants may not gain information about the specific permutations applied or the keys used by other participants. The privacy of shuffle methods, ephemeral keys, and final plaintext values may be maintained throughout the randomization and distribution process, with disclosure occurring through intentional revelation by the participant holding the relevant data or keys.

The selective information disclosure capabilities may address the limitation of conventional blockchain transparency by enabling applications where certain information is to remain private to specific participants while other information is made public. The system may support applications requiring both trustless randomization and selective disclosure, where conventional approaches may address one of these considerations but may not address both considerations in an integrated manner. A system that achieves trustless randomization may still fail to provide selective disclosure if all randomization steps are performed transparently on-chain. Conversely, a system that achieves selective disclosure through encryption may still rely on trusted parties for randomization. The trustless zero-knowledge randomization and distribution system may address both considerations through the combination of distributed encryption, zero-knowledge proofs, and hybrid on-chain/off-chain architecture.

### General Process Flow

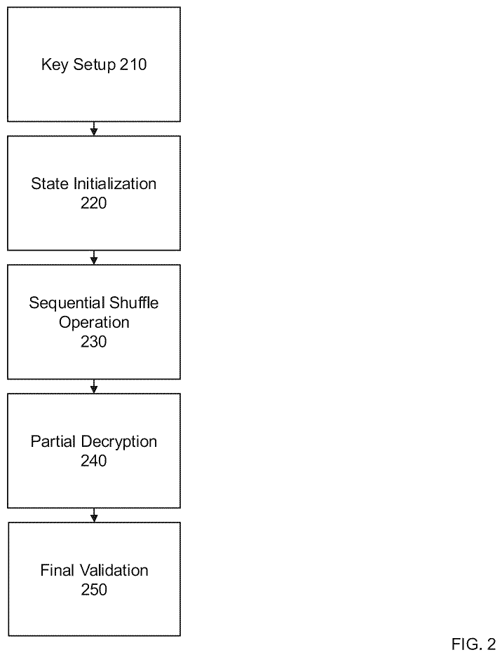

FIG. 2 depicts a flowchart illustrating a method for trustless randomization and distribution, according to aspects of the present disclosure. The method may comprise a key setup phase 210, a state initialization phase 220, a sequential shuffle operation phase 230, a partial decryption phase 240, and a final validation phase 250.

During the key setup phase 210, each participant may generate a private key off-chain. Each participant may derive a public key from the private key. Each participant may register the public key with the on-chain contract. The on-chain contract may compute an aggregated public key from the individual public keys of the participants.

During the state initialization phase 220, a dataset may be prepared for randomization. The dataset may be encrypted under the aggregated public key. The encrypted dataset may be placed on-chain. If the data items are privately contributed, each contributor may generate a per-contribution proof of well-formedness.

During the sequential shuffle operation phase 230, a current participant may acquire encrypted data from the on-chain contract. The current participant may apply a random permutation to the encrypted data off-chain. The current participant may apply re-encryption to the permuted data off-chain. The current participant may generate a zero-knowledge proof demonstrating correct shuffling. The current participant may submit the updated encrypted data and the proof to the on-chain contract. If additional participants remain, the process may repeat for the next participant. When all participants have completed shuffling, the method may proceed to the partial decryption phase 240.

During the partial decryption phase 240, a distribution policy may be determined for each ciphertext slot. If a slot is designated for private dealing, non-recipient participants may perform sequential partial decryption operations, and the designated recipient may perform final decryption locally to obtain plaintext. If a slot is designated for public reveal, all participants may perform sequential partial decryption operations.

During the final validation phase 250, the final holder may generate a consistency proof. The final holder may submit the plaintext and consistency proof to the on-chain contract. The on-chain contract may verify the consistency proof. If verification succeeds, the on-chain contract may record the revealed plaintext. If verification fails, the on-chain contract may reject the submission.

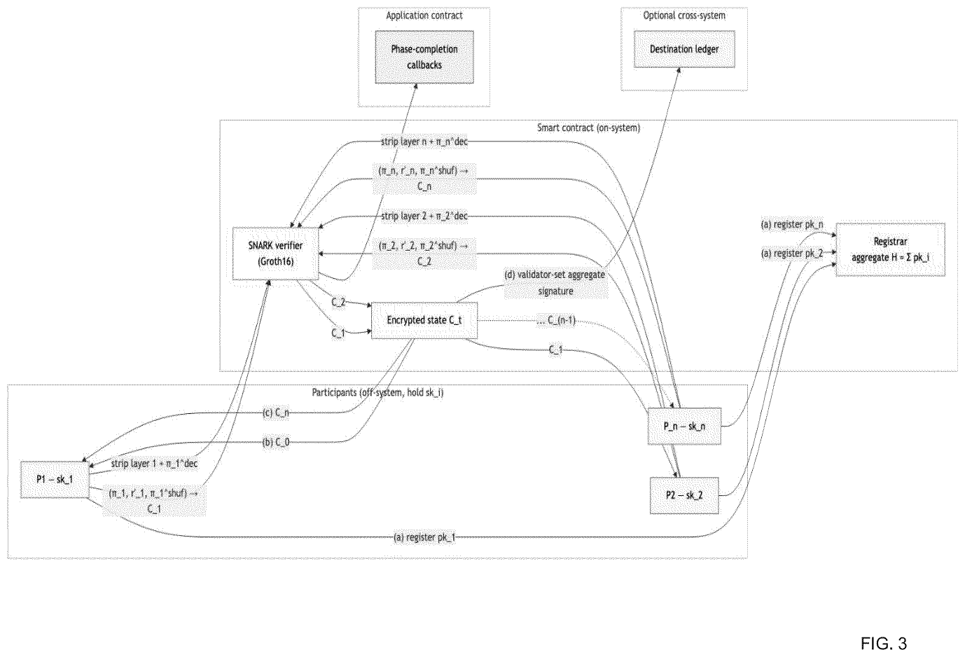

FIG. 3 depicts a protocol overview diagram 300 for a trustless zero-knowledge randomization and distribution system, according to aspects of the present disclosure. The diagram 300 may comprise three regions: a participant region, an on-chain contract region, and an application contract region.

The participant region may comprise a plurality of participant nodes P₁ through Pₙ. Each participant node may hold a private key skᵢ off-chain. The participant nodes may communicate with the on-chain contract region via network connections.

The on-chain contract region may comprise a smart contract holding an encrypted state vector C and a SNARK verifier. The on-chain contract may store the aggregated public key H computed as the sum of individual public keys. The on-chain contract may verify zero-knowledge proofs submitted by participants and may maintain the protocol transcript.

The application contract region may comprise an application contract that consumes phase-completion callbacks from the on-chain contract. The application contract may implement application-specific logic such as game phases, betting rounds, or bid windows.

The diagram illustrates four protocol flows. A registration flow illustrates the public keys pkᵢ being submitted to the on-chain contract, which computes the aggregated public key H=Σpkᵢ. A sequential shuffle flow illustrates the encrypted state transitioning from C₀ to C₁ to Cₙ, with each transition accompanied by a permutation Tn, re-randomization scalars r′ᵢ, and a shuffle proof π\hat{ }shuf_i. A layered partial decryption flow illustrates each participant Pⱼ stripping its encryption layer with a decryption proof π\hat{ }dec_j. An optional cross-system flow illustrates propagation from the on-chain contract to a destination ledger via a validator-set aggregate signature. The diagram further illustrates that no participant transmits its private key skᵢ and that the smart contract does not hold any secret.

### Key Setup Phase

In some implementations, the trustless zero-knowledge randomization and distribution system may begin with a key setup phase in which each participant of a plurality of participants generates cryptographic credentials. Each participant generates a private key on their own computer and publishes a corresponding public key to the blockchain. The public keys from all participants are combined into a single aggregated public key that will be used for encryption. In some implementations, no participant ever shares their private key, and no single participant can decrypt data without cooperation from the others.

During the key setup phase, each participant may generate a private key off-chain on a computing device controlled by the participant. The private key may be sampled from the scalar field [symbol] associated with the elliptic curve used for encryption operations. For a participant Pᵢ, the private key may be denoted skᵢ and may be sampled uniformly at random from the scalar field. Each participant may derive a public key from the private key of that participant. The public key pkᵢ may be computed as the scalar multiplication of the generator G of the prime-order group by the private key skᵢ. The public key computation may be expressed as: pkᵢ=skᵢ·G, where G is the generator of the prime-order subgroup G on the elliptic curve. The public key pk₁ may be a curve point in the prime-order group.

Each participant may publish the public key pkᵢ to an on-chain component as a registration transaction. The on-chain component may comprise a smart contract deployed on a blockchain platform. The smart contract may store references to the public credentials of each participant. The registration transaction may record the public key of the participant on-chain, making the public key visible to other participants and to the smart contract logic.

The private key skᵢ may remain stored locally on the computing device of the participant and may not be transmitted to other participants or recorded on-chain. No participant may transmit the private key of that participant to any other party. The separation of private key storage from on-chain operations may allow participants to contribute to the randomization process without exposing secret values to other participants or to observers of the blockchain.

After each participant has published a public key to the on-chain component, the on-chain component may compute an aggregated public key H from the individual public keys of the participants. The aggregated public key may be computed as the sum of the individual public keys. For n participants, the aggregated public key computation may be expressed as:

$$H = {\sum }_{i = 1}^{n} p {k}_{i} = ( {\sum }_{i = 1}^{n} s {k}_{i} ) \cdot G .$$

The aggregated public key H may be equivalent to the scalar multiplication of the generator G by the sum of the individual private keys. The on-chain component may compute the aggregated public key by summing the curve points corresponding to the individual public keys, without having access to the individual private keys. The summation of curve points may be performed using elliptic curve point addition operations.

The on-chain state at the end of the key setup phase may contain the individual public keys {pk₁, . . . , pkₙ} and the aggregated public key H. The individual public keys may be stored by the on-chain component for use in subsequent protocol phases, such as during partial decryption operations where each participant removes an encryption layer corresponding to the public key of that participant. The aggregated public key H may be used as the encryption key for ElGamal encryption operations during state initialization and shuffling phases.

No single participant may hold the aggregate private key corresponding to the aggregated public key H. The aggregate private key may be the sum

$${\sum }_{i = 1}^{n} s {k}_{i}$$

of the individual private keys, but no participant may have access to this sum because each participant may have access to the private key of that participant and may not have access to the private keys of other participants. The distribution of private key knowledge among the participants may provide that decryption of data encrypted under the aggregated public key H may involve cooperation of the participants through partial decryption operations.

The smart contract may reference the public credentials of each participant without storing or having access to the private keys. The smart contract may use the stored public keys to verify that subsequent protocol operations are performed by registered participants and to verify zero-knowledge proofs that reference the public keys. The smart contract may not hold any secret values, and the secrets associated with each participant may remain off-chain under the control of the respective participant.

### State Initialization

In some implementations, following the key setup phase, the trustless zero-knowledge randomization and distribution system may include a state initialization phase. During the state initialization phase, a dataset may be placed on-chain to establish the initial data state for subsequent randomization and distribution operations. The data items to be shuffled, such as cards or candidate identifiers, are encrypted and recorded on-chain. Depending on the application, the initial data may be publicly known items that are encrypted deterministically, or privately contributed items where each contributor proves their item is valid without revealing what it is. The dataset may be placed on-chain in encrypted form or as placeholders, depending on the application requirements and the nature of the data items in the dataset.

In some implementations, the dataset may comprise a collection of data items to be randomized and selectively distributed. In some aspects, the dataset may comprise a deck of cards for gaming applications. In some aspects, the dataset may comprise a registry of candidate identifiers for jury selection or panel selection applications. In some aspects, the dataset may comprise sealed bids for auction applications. In some aspects, the dataset may comprise ballots for voting applications. In some aspects, the dataset may comprise other collections of data items suitable for randomization and selective distribution. The state initialization phase may proceed differently depending on whether the data items in the dataset are publicly known a priori or are privately contributed by individual participants.

When the data items are publicly known a priori, the initial encrypted state may be computed deterministically from an encoding rule and a public seed. Data items that are publicly known a priori may include playing cards in a card game application, where the set of cards in a standard deck is known to all participants before the protocol begins. Data items that are publicly known a priori may also include candidate identifiers in ajuror registry, where the registry of eligible jurors is publicly available before the selection process begins.

For data items that are publicly known a priori, each data item may be mapped to a curve point in the prime-order group G using an application-specific deterministic encoding function. The encoding function may map each data item to a corresponding curve point according to a predefined mapping rule. For a card game application, the encoding function may map each of 52 playing cards to a corresponding curve point. For a jury selection application, the encoding function may map each candidate identifier in the registry to a corresponding curve point.

The initial encrypted state C₀ may be computed by encrypting each encoded data item under the aggregated public key H using ElGamal encryption. The encryption may use randomness values derived from a public seed. Because the encoding rule and the public seed are both publicly known, any verifier may recompute the initial encrypted state C₀ independently. The ability of any verifier to recompute the initial encrypted state may eliminate the requirement for a validity proof during initialization. When the initial encrypted state may be recomputed by any verifier from publicly known information, the on-chain contract may verify the correctness of the initial encrypted state by recomputation rather than by proof verification.

When the data items are privately contributed by individual participants, each contributor may encrypt the contributed data item under the aggregated public key H. Privately contributed data items may include sealed bids in auction applications, where each bidder submits a bid value that is intended to remain confidential until a designated revelation time. Privately contributed data items may also include ballots in voting applications, where each voter submits a vote that is intended to remain confidential while the aggregate result is made public.

For privately contributed data items, each contributor may generate a ciphertext by encrypting the contributed data item using ElGamal encryption under the aggregated public key H. The contributor may sample randomness locally and compute the ciphertext as a pair of group elements. The ciphertext may be submitted to the on-chain contract for inclusion in the dataset.

Each contributor of a privately contributed data item may generate a per-contribution proof of well-formedness. The per-contribution proof of well-formedness may demonstrate that the contributed data item belongs to a permitted set of valid data items. The permitted set may be defined by the application. In an auction application, the permitted set may comprise bid values within a valid range or bid values that satisfy application-specific constraints. In a voting application, the permitted set may comprise valid ballot options corresponding to the candidates or choices available in the election.

The per-contribution proof of well-formedness may be a zero-knowledge proof that demonstrates the contributed data item belongs to the permitted set without revealing the specific data item contributed. The proof may demonstrate that the plaintext encrypted in the submitted ciphertext corresponds to one of the valid data items in the permitted set. The proof may prevent a contributor from submitting an invalid data item, such as a bid value outside the permitted range or a ballot option that does not correspond to a valid candidate.

The on-chain contract may verify each per-contribution proof of well-formedness before accepting the contributed ciphertext into the dataset. The verification may confirm that the proof is valid and that the contributed data item belongs to the permitted set. If the proof verification fails, the on-chain contract may reject the contribution, preventing invalid data items from being included in the dataset.

The per-contribution proof of well-formedness may be application-specific and may be orthogonal to the shuffle primitive. The structure and constraints of the well-formedness proof may vary depending on the application requirements and the definition of the permitted set. The shuffle primitive may operate on the initialized dataset regardless of whether the dataset was initialized from publicly known data items or from privately contributed data items.

The completion of the state initialization phase may establish the initial data state for the randomization and distribution protocol. The initialized dataset, whether computed deterministically from publicly known data items or assembled from privately contributed data items with well-formedness proofs, may serve as the starting point for subsequent shuffling operations. The initial encrypted state may comprise a vector of ciphertexts

$${C}_{0} = ( c {t}_{1}^{( 0 )} , … , c {t}_{q}^{( 0 )} ) ,$$

where each ciphertext encrypts a data item from the dataset under the aggregated public key H. Subsequent protocol phases may build upon the initialized dataset, with each operation verified by proofs that maintain the chain of integrity from the initial state through the final distribution of data items.

### Sequential Shuffle Operation

In some implementations, following the state initialization phase, the trustless zero-knowledge randomization and distribution system may include a sequential shuffle operation phase. During the sequential shuffle operation phase, participants may collectively randomize the dataset through a series of individual shuffling operations performed in a deterministic turn order. Each participant downloads the current encrypted data, applies a random reordering, adds fresh encryption, and uploads the result along with a proof that the operation was performed correctly. After all participants have shuffled, the data is in a random order that no single participant could have predicted or controlled.

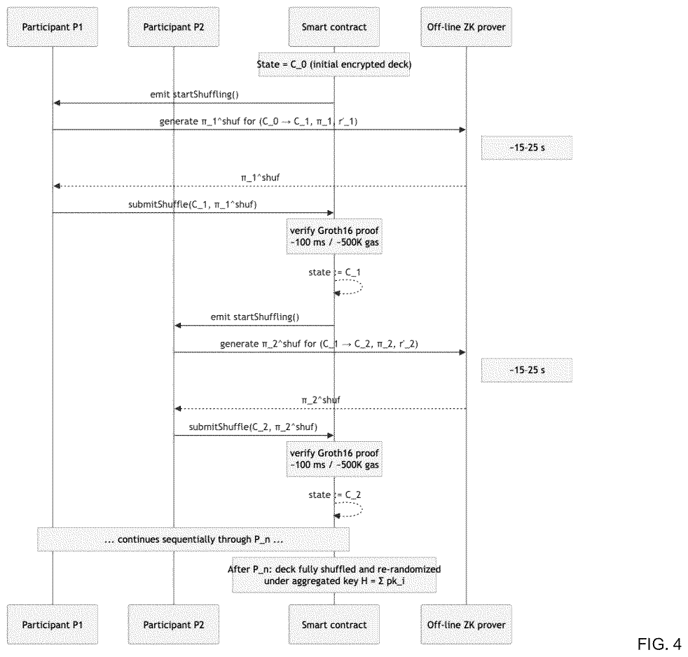

FIG. 4 depicts a sequence diagram illustrating a shuffle phase of a trustless randomization and distribution method, according to aspects of the present disclosure. The sequence diagram comprises interactions between a first participant P₁, a second participant P₂, a smart contract, and an off-chain zero-knowledge prover. A time axis flows from the top of the diagram to the bottom of the diagram.

In some implementations, the smart contract may emit a startShuffling( ) notification to the first participant P₁. The first participant P₁ may generate a shuffle proof off-chain using the zero-knowledge prover. In some implementations, the first participant P₁ may submit the updated encrypted state C₁ and the shuffle proof π\hat{ }shuf_1 to the smart contract. In some implementations, the smart contract may verify the shuffle proof.

In some implementations, the smart contract may emit a startShuffling( ) notification to the second participant P₂. In some implementations, the second participant P₂ may generate a shuffle proof off-chain using the zero-knowledge prover. In some implementations, the second participant P₂ may submit the updated encrypted state C₂ and the shuffle proof π\hat{ }shuf_2 to the smart contract. In some implementations, the smart contract may verify the shuffle proof.

The sequence diagram illustrates the sequential dependency of the shuffle phase, where each participant must wait for the previous participant to complete before beginning their shuffle operation. The shuffle proofs may not be parallelized across participants due to this sequential dependency.

During the sequential shuffle operation phase, a participant may acquire current encrypted data from the on-chain contract. The participant may retrieve references to the encrypted data items stored on-chain, along with any associated metadata indicating the current state of the dataset. The encrypted data may represent the output of the state initialization phase or the output of a previous participant's shuffling operation. The participant may download or access the encrypted data references from the on-chain contract to obtain the current ciphertext state of the dataset. For a participant Pᵢ performing a shuffling operation, the current ciphertext state may be denoted

$${C}_{i - 1} = ( c {t}_{1}^{( i - 1 )} , … , {ct}_{q}^{( i - 1 )} ) ,$$

where q is the number of data items in the dataset.

After acquiring the current encrypted data, the participant may apply a random permutation to the encrypted data locally. The random permutation may reorder the encrypted data items according to a randomly generated ordering. The participant may generate the random permutation using local entropy sources on the participant's computing device. The permutation may be generated without input from other participants, the blockchain, or external sources, providing that the permutation remains under the sole control of the participant generating the permutation.

In addition to applying the random permutation, the participant may apply re-encryption to the permuted data locally. The re-encryption operation may add fresh randomness to each ciphertext without decrypting the ciphertext. The participant may sample a vector of re-randomization scalars rᵢ from the scalar field [symbol] . For each permuted ciphertext, the re-encryption operation may add rᵢ, to the first ciphertext component and r to the second ciphertext component, where G is the generator of the prime-order group and H is the aggregated public key. The resulting ciphertext may be indistinguishable from a fresh encryption of the same plaintext under the aggregated public key H.

The combination of permutation and re-encryption may be performed as a single local operation or as sequential local operations. The participant may first permute the encrypted data items according to the random permutation and then apply re-encryption to each permuted data item. In some implementations, the participant may apply techniques that simultaneously permute and re-encrypt the data items. The local nature of the permutation and re-encryption operations may provide that the specific permutation applied, and the re-encryption parameters used, remain known to the performing participant and are not disclosed to other participants or observers of the blockchain. The output of the shuffling operation may be a new ciphertext vector

$${C}_{i} = ( c {t}_{1}^{( i )} , … , {ct}_{q}^{( i )} ) .$$

After applying the random permutation and re-encryption locally, the participant may generate a zero-knowledge proof demonstrating that the shuffling operation was performed correctly. The participant may generate a Groth16 proof

$${π}_{i}^{shuf}$$

for a shuffle relation. The shuffle relation may be expressed as: R_{shuf}={(Cᵢ₋₁, Cᵢ, H; Πᵢ, rᵢ):Cᵢ=ReRand(Πᵢ·Cᵢ₋₁; rᵢ)}.

The witness for the zero-knowledge proof may comprise a permutation matrix Πᵢi∈{0,1}^{q×q} and the vector of re-randomization scalars rᵢ. The permutation matrix Πᵢ may encode the permutation applied by the participant, with one entry equal to 1 per row and one entry equal to 1 per column.

A shuffle circuit may verify the correctness of the shuffling operation within the zero-knowledge proof system. The shuffle circuit may check that the permutation matrix H₁ is valid. A valid permutation matrix may have one entry equal to 1 per row and one entry equal to 1 per column, with all other entries equal to 0. The shuffle circuit may verify that the permutation matrix satisfies these constraints, confirming that the matrix represents a valid permutation rather than a transformation that adds, removes, or duplicates data items.

The shuffle circuit may further check that each output ciphertext equals the re-randomized permuted input. For each index j, the shuffle circuit may verify that

$$c {t}_{j}^{( i )} = R e R a {nd ( {\prod }_{i} \cdot {C}_{i - 1} )}_{j}$$

in BabyJubJub coordinates. The verification may confirm that the output ciphertext at each position corresponds to a re-randomized version of the input ciphertext at the permuted position. The shuffle circuit may verify these conditions without revealing the permutation matrix or the re-randomization values used during the shuffle operation.

The shuffle circuit may also check that the public input commits to the input ciphertext vector, output ciphertext vector, and aggregated public key via hashing. The commitment may be computed using Pedersen hashing or Poseidon hashing. The commitment may bind the proof to the specific values (Cᵢ₋₁, Cᵢ, H), preventing input-substitution attacks where an adversary attempts to associate a valid proof with different public inputs than those for which the proof was generated. The binding property of the commitment may provide that an adversary cannot find two different sets of inputs that produce the same commitment value, except with negligible probability.

The participant may then update the chain with the new data and the zero-knowledge proof. The participant may submit a transaction to the on-chain contract that includes references to the new encrypted data state Cᵢ and the zero-knowledge proof

$${r}_{tot , j} = {\sum }_{i} {r}_{i , j}$$

The on-chain contract may verify the zero-knowledge proof to confirm that the submitted data represents a valid transformation of the previous data state. If the proof verification succeeds, the on-chain contract may update the stored data references to reflect the new encrypted data state and may advance the turn indicator to the next participant. If the proof verification fails, the on-chain contract may reject the transaction, preventing invalid shuffling operations from being recorded on-chain.

The shuffling step may be repeated for each participant in a deterministic turn order to provide collective randomness. After a first participant completes a shuffling operation and updates the chain with new data and a proof, a second participant may acquire the updated encrypted data from the chain and perform a subsequent shuffling operation. The second participant may apply a different random permutation and re-encryption, further randomizing the dataset. The process may continue with additional participants, with each participant contributing randomness through local permutation and re-encryption operations. The deterministic turn order may be enforced by the on-chain contract, which may track the current turn and accept shuffling submissions from the designated participant for each turn.

After n valid turns by n participants, the on-chain contract may hold Cₙ, a uniformly permuted and jointly re-randomized vector of ciphertexts. The joint permutation π=πₙ ∘ . . . ∘π₁ may represent the composition of the individual permutations applied by each participant. The cumulative randomness

$${r}_{tot , j} = {\sum }_{i} {r}_{i , j}$$

may represent the sum of the re-randomization scalars applied to each ciphertext position across all shuffling operations. The joint permutation and the cumulative randomness may be unknown to all parties due to the composition of the per-step zero-knowledge property.

The iterative nature of the shuffling process may provide security properties related to collective randomness. Because each participant applies an independent random permutation, the final ordering of the dataset may reflect the combined randomness contributions of all participating shufflers. A participant who attempts to bias the final ordering may be unable to predict or control the permutations applied by other participants. Even if one participant applies a non-random or biased permutation, the permutations applied by other honest participants may randomize the dataset. The collective randomness property may provide that the final shuffled state is unpredictable to any single participant, provided that at least one participant applies a genuinely random permutation.

The on-chain verification of zero-knowledge proofs during the shuffling process may enforce protocol compliance. Each participant's shuffling operation may be verified by the on-chain contract before the updated data references are accepted. The verification may confirm that the submitted proof corresponds to a valid transformation from the previous ciphertext state to the new ciphertext state. A participant who attempts to submit an invalid transformation, such as a transformation that adds, removes, or duplicates data items, may be detected by the proof verification logic. The enforcement of valid transformations through on-chain proof verification may maintain the integrity of the dataset throughout the shuffling process.

The local nature of the shuffle encryption process may maintain privacy while enabling verification. Because the permutation and re-encryption operations are performed locally on the participant's computing device, the specific permutation applied may remain concealed from other participants and from observers of the blockchain. Other participants may observe the input ciphertext state and the output ciphertext state recorded on-chain, but other participants may not be able to determine the mapping between input positions and output positions. The zero-knowledge proof may provide cryptographic assurance that the mapping represents a valid permutation without revealing the permutation itself.

The privacy properties of the local shuffling process may extend to the re-encryption values used during the operation. The re-randomization scalars generated for the shuffling operation may remain stored locally on the participant's device and may not be transmitted to other participants or recorded on-chain. The zero-knowledge proof may demonstrate that valid re-encryption was applied without revealing the re-randomization scalars. Other participants may verify that the shuffling operation was performed correctly based on the proof, while remaining unable to derive the re-randomization scalars or reverse the re-encryption applied by the shuffling participant.

### Partial Decryption and Distribution

In some implementations, following the completion of the shuffling process, the trustless zero-knowledge randomization and distribution system may include a partial decryption phase. During the partial decryption phase, multiple participants may remove encryption layers in turn off-chain through sequential layer decryption. Each participant removes their layer of encryption in sequence. For items intended for a specific recipient, that recipient performs the final decryption privately. For items intended to be public, the final decrypted value is posted along with a proof of correctness. The partial decryption phase may enable the system to reveal data items to designated recipients while maintaining the privacy of data items intended for other recipients.

During the shuffling process, each participant may have applied an encryption layer to the dataset using the participant's cryptographic keys. The encrypted data items stored on-chain after the shuffling process may contain multiple encryption layers, with each layer corresponding to the encryption applied by a respective participant during shuffling. To reveal a data item, the encryption layers may be removed in sequence by the participants who applied the encryption layers.

An application-level distribution policy may specify, for each ciphertext slot in the shuffled dataset, a target for distribution. The distribution policy may specify targets including public reveal, private dealing to a designated recipient, conditional reveal based on a state predicate, or cross-system propagation to a destination ledger. For public reveal, the plaintext may be made visible to all participants and recorded on-chain after all encryption layers are removed. For private dealing, the plaintext may be delivered to a designated recipient without revealing the plaintext to other participants. For conditional reveal, the partial decryption operations may be gated on a state predicate, such as a game-state phase, a wall-clock time, or an external oracle signal. For cross-system propagation, the partially decrypted ciphertext may be propagated to a destination ledger for consumption by applications on the destination ledger.

For each ciphertext slot to be revealed, the distribution may proceed as a sequence of partial-decryption layers. For each participant Pⱼ in a layer-stripping order, the participant Pⱼ may fetch the current ciphertext (c₀, c₁) for the slot. The current ciphertext may be the ciphertext recorded on-chain after the shuffling process, or the current ciphertext may be an intermediate ciphertext resulting from partial decryption operations performed by preceding participants in the layer-stripping order. The participant Pⱼ may compute a layer-stripped ciphertext by applying a partial decryption operation. The partial decryption operation may produce an updated ciphertext (c₀, c₁ where the second component is computed as:

$${c}_{1}^{′} = {c}_{1} - s {k}_{j} \cdot {c}_{0} ,$$

where skⱼ is the private key of participant Pⱼ and c₀ is the first component of the ciphertext. The first component c₀ may remain unchanged during the partial decryption operation. The partial decryption operation may remove the encryption layer that was applied by participant Pⱼ during the shuffling process.

The participant Pⱼ may generate a zero-knowledge proof

$${π}_{j}^{dec}$$

demonstrating that the partial decryption operation was performed correctly. A decryption circuit may verify the correctness of the partial decryption operation within the zero-knowledge proof system. The decryption circuit may verify the relation:

$${R}_{dec} = \{ ( p {k}_{j} , {c}_{0} , {c}_{1} , {c}_{1}^{′} ; s {k}_{j} ) : {pk}_{j} = s {k}_{j} \cdot G ⋀ {c}_{1}^{′} = {c}_{1} - s {k}_{j} \cdot {c}_{0} \} .$$

The decryption circuit may verify that the public key pkⱼ equals the scalar multiplication of the generator G by the private key skⱼ. The decryption circuit may further verify that the updated second ciphertext component

$${c}_{1}^{′}$$

equals the original second ciphertext component c₁ minus the scalar multiplication of the first ciphertext component c₀ by the private key skⱼ. The decryption circuit may verify these conditions to prove correct layer stripping without revealing the private key skⱼ.

The participant Pⱼ may submit the layer-stripped ciphertext and the zero-knowledge proof

$${π}_{j}^{dec}$$

to the on-chain contract. The on-chain contract may verify the zero-knowledge proof and advance the slot's ciphertext to the updated ciphertext (c₀, c₁). If the proof verification succeeds, the on-chain contract may update the stored ciphertext reference for the slot. If the proof verification fails, the on-chain contract may reject the submission.

The partial decryption operations may be performed off-chain by individual participants. Each participant may receive the current ciphertext state, apply the partial decryption operation locally using the participant's private key, and transmit the resulting intermediate ciphertext to the next participant in the decryption sequence. The off-chain nature of the partial decryption operations may reduce on-chain transaction costs and may allow the decryption process to proceed without recording each intermediate ciphertext state on the blockchain.

The order of partial decryption operations may correspond to the order in which encryption layers were applied during shuffling, or the order may be reversed depending on the cryptographic scheme employed. In some implementations, the partial decryption operations may be performed in reverse order relative to the encryption operations, with the last participant to apply encryption during shuffling being the first participant to apply partial decryption. In some implementations, the cryptographic scheme may allow partial decryption operations to be performed in any order, with each participant removing the encryption layer corresponding to that participant regardless of the order in which other participants perform partial decryption.

In the private-dealing case, after all n−1 non-recipient layers have been removed, the residual ciphertext for a slot may have the form

$$( {c}_{0}^{*} , {c}_{1}^{*} )$$

where

$${c}_{1}^{*} = {m}_{π ( j )} + {sk}_{k} \cdot {c}_{0}^{*} ,$$

with skₖ being the designated recipient's private key. The designated recipient Pₖ may recover the plaintext locally as:

$${m}_{π ( j )} = {c}_{1}^{*} - s {k}_{k} \cdot {c}_{0}^{*} .$$

The designated recipient may retain the plaintext without disclosing the plaintext to other participants. In card game applications, a card dealt to a specific player may be decrypted through sequential partial decryption by all participants except the designated player, with the designated player performing the final decryption locally. The designated player may obtain the plaintext card value and may view the card privately without revealing the card value to other players.

In the public-reveal case, after all n layers are stripped, the residual second ciphertext component

$${c}_{1}^{*}$$

may equal the plaintext m_{π(j)}. The on-chain contract may record the plaintext together with a consistency proof binding the plaintext to the on-chain history. The consistency proof may demonstrate that the plaintext corresponds to the correct decryption of the ciphertext that was recorded on-chain after the shuffling process.

For conditional reveal, the on-chain contract may gate partial-decryption transactions on a state predicate. The state predicate may comprise a game-state phase condition, a wall-clock time condition, an external oracle signal, or other application-specific conditions. Partial decryption operations for a conditional-reveal slot may be accepted by the on-chain contract when the state predicate evaluates to true. The conditional reveal mechanism may enable applications to control the timing of data revelation based on application-specific logic.

For cross-system propagation, the partially decrypted ciphertext may be propagated to a destination ledger via the destination ledger's incoming-message verification mechanism. The incoming-message verification mechanism may comprise a stake-weighted validator-quorum signature on the source ledger or other cross-chain verification approaches. The destination ledger may treat the propagated ciphertext as authoritative without re-running the underlying zero-knowledge proof verification. Cross-system propagation may enable applications where randomized data items are to be consumed by smart contracts or applications on a different blockchain platform than the platform on which the shuffling and partial decryption operations were performed.

The sequential nature of the partial decryption process may distribute the decryption authority among multiple participants. No single participant may be able to decrypt a data item without the cooperation of other participants who applied encryption layers during shuffling. The distribution of decryption authority may prevent any single participant from unilaterally accessing plaintext data items before the designated reveal time.

The partial decryption phase may support various distribution patterns depending on the requirements of the application. In some implementations, different data items may be distributed to different recipients, with each data item undergoing a separate partial decryption sequence that terminates with the designated recipient. In some implementations, multiple data items may be revealed publicly through partial decryption sequences that terminate with public posting of the plaintext values. The combination of off-chain partial decryption operations and selective plaintext handling may enable the system to achieve selective information disclosure.

### Validation

In some implementations, publicly revealed data must be verified to be correct by the system. When a data item is revealed, the revealing party must provide a proof showing that the revealed value matches the encrypted value that was shuffled. This prevents anyone from substituting a different value during the reveal process. The blockchain verifies this proof before accepting the revealed data.

In some implementations, the trustless zero-knowledge randomization and distribution system may include a final validation phase that enables public verification of data integrity when data items are revealed. During the final validation phase, when a data item is to be publicly known, a final holder of the data item may publish the plaintext data along with a consistency proof. The final holder may be the participant who obtained the plaintext through the partial decryption phase, either as the last participant in the decryption sequence or as a designated recipient of the data item.

When a slot is publicly revealed, the revealing party may submit the recovered plaintext m together with a reveal proof π^{rev} for a reveal relation. The reveal relation may be expressed as: Rᵣₑᵥ={(Cₙ[j],m,decChain;⋅):m=Dec(Cₙ[j],decChain)}

The reveal circuit may prove that the revealed plaintext mis consistent with the chain of accepted partial decryptions from the on-chain ciphertext history. The reveal circuit may verify that the plaintext m corresponds to the correct decryption of the ciphertext Cₙ at slot j that was recorded on-chain after the shuffling process. The reveal circuit may further verify that the layer chain of partial decryption operations was performed correctly, with each partial decryption step corresponding to a valid removal of an encryption layer by a registered participant.

The consistency proof may demonstrate a mathematical relationship between the published plaintext and the previously known ciphertext. The proof may show that the plaintext, when encrypted using the cryptographic parameters established during the protocol, produces the ciphertext that was recorded on-chain after the shuffling process. The consistency proof may be generated using zero-knowledge proof techniques that allow verification of the relationship without revealing the private keys or intermediate values used in the encryption and decryption operations.

The final holder may submit the plaintext and the consistency proof to the on-chain contract for verification. The on-chain contract may retrieve the previously recorded ciphertext associated with the data item being revealed. The on-chain proof verification logic may process the consistency proof to determine whether the proof is valid. The verification may confirm that the submitted plaintext corresponds to the correct decryption of the recorded ciphertext. The on-chain component may verify and record the plaintext m upon successful proof verification.

The on-chain proof verification logic may reject submissions where the consistency proof is invalid. If a final holder attempts to publish a plaintext value that does not correspond to the previously recorded ciphertext, the proof verification logic may detect the inconsistency and reject the submission. The rejection may prevent the invalid plaintext from being recorded on-chain as the revealed value for the data item. The enforcement of consistency through proof verification may prevent final holders from substituting different plaintext values during the reveal phase. The final validation step may prevent a malicious final-layer decryptor from substituting an unrelated plaintext m′ for the correct plaintext m.

The chain's logic via proof verification may ensure no tampering during final validation. The immutability of blockchain records may ensure that the previously recorded ciphertext may not be altered after recording. The proof verification logic implemented on-chain may enforce that revealed plaintext values correspond to the immutable ciphertext records. The combination of immutable ciphertext records and enforced consistency verification may provide tamper-proof assurance that the final revealed data is the correct output of the randomization and distribution protocol.

In some implementations, the consistency proof may be verified by any participant or observer with access to the on-chain data. The previously recorded ciphertext may be publicly visible on the blockchain, and the consistency proof may be submitted as part of the reveal transaction. Any party may verify that the proof is valid by executing the proof verification logic, either through the on-chain contract or through independent off-chain verification. The public verifiability of the consistency proof may provide transparency regarding the correctness of the reveal operation.

The consistency proof publication may enable public verification of data integrity without compromising the security of the underlying cryptographic operations. Participants and observers may verify that the revealed plaintext is consistent with the ciphertext that was processed through the shuffling and partial decryption phases. The verification may occur without revealing the private keys used by participants during encryption and decryption operations. The verification may also occur without revealing the specific permutations applied during shuffling operations. The zero-knowledge nature of the consistency proof may allow verification of correctness while preserving the privacy of the cryptographic parameters.

In some implementations, the final validation phase may be applied to multiple data items within a protocol session. Each data item that is to be publicly revealed may undergo a separate final validation process, with the final holder of each data item publishing the plaintext and consistency proof for that data item. The on-chain contract may track which data items have been revealed and may verify the consistency proof for each revealed data item.

The final validation phase may complete the chain of cryptographic verification that extends from initialization through shuffling, partial decryption, and final reveal. The initialization phase may establish the validity of the initial dataset through a creation proof. The shuffling phase may verify each participant's shuffling operation through zero-knowledge proofs of correct permutation and re-encryption. The partial decryption phase may verify each participant's decryption operation through proofs of correct partial decryption. The final validation phase may verify that revealed plaintext values are consistent with the ciphertext that resulted from the verified shuffling and decryption operations. The chain of verification may provide end-to-end cryptographic assurance that the randomization and distribution protocol was executed correctly.

### Conditional and Cross-System Distribution

In some implementations, the system may comprise advanced distribution options beyond simple public reveal or private delivery. Conditional reveal allows data to be revealed only when certain conditions are met, such as reaching a specific time or game phase. Cross-system distribution allows shuffled data to be securely transferred to a different blockchain for use by applications on that chain. The trustless zero-knowledge randomization and distribution system may support conditional reveal and cross-system distribution as distribution targets for ciphertext slots in the shuffled dataset.

For conditional reveal, an on-chain component may gate partial-decryption transactions on a predicate. The predicate may comprise a game-state phase condition, a wall-clock time condition, an external oracle signal, or other application-specific conditions. The on-chain contract may evaluate the predicate before accepting partial-decryption transactions for a conditional-reveal slot. When the predicate evaluates to true, the on-chain contract may accept partial-decryption transactions for the conditional-reveal slot. When the predicate evaluates to false, the on-chain contract may reject partial-decryption transactions for the conditional-reveal slot.

A game-state phase predicate may gate partial-decryption transactions based on the current phase of a game or application. In card game applications, a game-state phase predicate may specify that a community card may be revealed when the game reaches a designated phase, such as a flop phase, a turn phase, or a river phase in poker. The on-chain contract may track the current game-state phase and may accept partial-decryption transactions for a conditional-reveal slot when the game-state phase matches the predicate condition.

A wall-clock time predicate may gate partial-decryption transactions based on a timestamp or time condition. In auction applications, a wall-clock time predicate may specify that bid values may be revealed after a designated auction closing time. The on-chain contract may compare the current block timestamp or an external time reference against the predicate condition and may accept partial-decryption transactions when the time condition is satisfied.

An external oracle signal predicate may gate partial-decryption transactions based on a signal received from an external oracle. The external oracle may provide information from off-chain sources, such as real-world events, external data feeds, or signals from other systems. The on-chain contract may query the oracle or receive oracle updates and may accept partial-decryption transactions when the oracle signal satisfies the predicate condition.

The conditional reveal mechanism may enable applications to control the timing of data revelation based on application-specific logic. Participants may submit partial-decryption transactions at any time, but the on-chain contract may hold the transactions or reject the transactions until the predicate condition is satisfied. The gating of partial-decryption transactions on predicates may provide that data items are revealed according to application-defined rules rather than at the discretion of individual participants.

For cross-system distribution, the trustless zero-knowledge randomization and distribution system may propagate partially decrypted ciphertext or fully decrypted plaintext to a destination ledger. Cross-system distribution may enable applications where randomized data items are to be consumed by smart contracts or applications on a different blockchain platform than the platform on which the shuffling and partial decryption operations were performed.

Cross-system distribution may rely on destination-side verification of an aggregated signature from the source ledger's validator set. The aggregated signature may comprise a stake-weighted BLS (Boneh-Lynn-Shacham) multisignature. The stake-weighted BLS multisignature may aggregate signatures from multiple validators on the source ledger, with each validator's contribution weighted according to the validator's stake in the source ledger's consensus mechanism.

The source ledger's validators may sign a message attesting to the state of the partially decrypted ciphertext or the revealed plaintext. The validators may each produce a BLS signature on the message using the validator's private signing key. The individual BLS signatures may be aggregated into a single multisignature. The aggregation may weight each validator's signature according to the validator's stake, such that the multisignature reflects the collective attestation of the validator set weighted by stake.

The destination ledger may verify the aggregated signature to confirm that the propagated data is authoritative. The destination ledger may maintain a record of the source ledger's validator set and the associated public keys. The destination ledger may verify that the aggregated signature is valid with respect to the validator set and that the stake weight of the signing validators exceeds a threshold. Upon successful verification of the aggregated signature, the destination ledger may accept the propagated data as authoritative.

A destination consumer on the destination ledger may treat the propagated ciphertext or plaintext as authoritative without re-running the underlying zero-knowledge proof verification. The destination consumer may rely on the aggregated signature from the source ledger's validator set as attestation that the zero-knowledge proofs were verified on the source ledger. The destination consumer may thereby consume the propagated data without incurring the computational cost of zero-knowledge proof verification on the destination ledger.

The trust assumption for cross-system distribution may be separate from the 1-of-n cryptographic honesty assumption of the randomization and distribution protocol. The 1-of-n cryptographic honesty assumption may provide that the joint permutation is computationally indistinguishable from a uniformly random permutation if at least one participant is honest. The cross-system distribution trust assumption may provide that the destination ledger trusts the source ledger's validator set to accurately attest to the state of the propagated data. The 1-of-n cryptographic property may not be weakened by cross-system propagation. The destination's confidence in the propagation may be parameterized by the source ledger's validator-set integrity.

In some implementations, alternative deployments may re-verify the underlying zero-knowledge proof on the destination ledger for redundant trust. The destination ledger may verify the zero-knowledge proof in addition to verifying the aggregated signature from the source ledger's validator set. The redundant verification may provide additional assurance that the propagated data corresponds to correctly executed protocol operations, at the cost of additional computational overhead on the destination ledger.

### Timeout and Enforcement Mechanisms

This section describes how the system handles participants who fail to act or who act incorrectly. In some implementations, each participant must complete their turn within a time limit, and each participant posts a security deposit that can be forfeited for misbehavior. If a participant fails to act, submits an invalid proof, or refuses to decrypt when required, their deposit may be forfeited and distributed to the other participants. The trustless zero-knowledge randomization and distribution system may employ a per-turn timeout mechanism to enforce timely participant actions. The on-chain component may track the current turn and may record a timestamp or block number at which the current turn began. The on-chain component may compare the elapsed time or block count against a timeout threshold to determine whether the current participant has exceeded the allotted time for the turn.

In some implementations, the per-turn timeout may default to 30 seconds. The 30-second default timeout may provide sufficient time for participants to generate zero-knowledge proofs and submit transactions to the on-chain component while limiting the duration that other participants wait for a single participant to act. In some implementations, the timeout duration may be configurable and may be set to different values depending on application requirements, network conditions, or the computational complexity of the operations to be performed during the turn.

Each participant may post a security deposit at registration. The security deposit may be held by the on-chain component and may serve as collateral to incentivize honest participation in the protocol. The security deposit may be denominated in the native currency of the blockchain platform or in a token specified by the protocol parameters. The on-chain component may record the deposit amount associated with each registered participant.

Failure to act within the timeout period may result in deposit forfeiture and participant removal. When a participant fails to submit a valid transaction before the timeout expires, the on-chain component may trigger an enforcement action. The enforcement action may comprise forfeiting the deposit of the non-acting participant and removing the non-acting participant from the active participant set. The on-chain component may advance the protocol state to account for the removal of the non-acting participant, and the application may be notified of the participant removal.

Submission of an invalid proof may result in deposit forfeiture and participant removal. When a participant submits a zero-knowledge proof that fails verification by the on-chain component, the on-chain component may trigger an enforcement action. The enforcement action may comprise forfeiting the deposit of the participant who submitted the invalid proof and removing the participant from the active participant set. The rejection of invalid proofs may prevent participants from submitting fraudulent shuffle operations or decryption operations.

Refusal to publish a partial decryption when the partial decryption is required by the protocol may result in deposit forfeiture and participant removal. During partial decryption phases, each participant may be required to remove an encryption layer from designated ciphertext slots according to the distribution policy. When a participant fails to submit the partial decryption within the timeout period or submits an invalid partial decryption proof, the on-chain component may trigger an enforcement action. The enforcement action may comprise forfeiting the deposit of the non-compliant participant and removing the non-compliant participant from the active participant set.

Forfeited deposits from failed or malicious participants may be redistributed pro rata to honest survivors. When a participant's deposit is forfeited due to failure to act, submission of an invalid proof, or refusal to publish a partial decryption, the on-chain component may distribute the forfeited deposit among the remaining participants who have not been removed from the active participant set. The redistribution may be performed on a pro rata basis, where each honest survivor receives a share of the forfeited deposit proportional to the honest survivor's own deposit or proportional to an equal division among the honest survivors.

The deposit forfeiture and redistribution mechanism may provide economic enforcement of protocol compliance. Participants who fail to act, submit invalid proofs, or refuse to publish partial decryptions may incur a financial penalty through loss of the security deposit. Honest participants who continue to participate in the protocol may receive compensation through redistribution of forfeited deposits. The economic enforcement mechanism may be layered above the cryptographic security properties of the protocol and may incentivize timely and correct participation.

Following deposit forfeiture and participant removal, the protocol may continue with the remaining quorum of participants or may be gracefully aborted at the application's discretion. The on-chain component may notify the application of the participant removal, and the application may determine whether to continue the protocol with the reduced participant set or to abort the protocol session. In some implementations, the protocol may continue with the remaining participants if the remaining participants are sufficient to complete the randomization and distribution operations. In some implementations, the application may specify a minimum quorum size, and the protocol may abort if the number of remaining participants falls below the minimum quorum size.

### Voluntary Departure and Dropout Handling

In some implementations, participants may need to leave the protocol before it completes. In some implementations, a departing participant must first remove their encryption layer from all relevant data items so that the remaining participants can continue without them. This ensures that one participant's departure does not prevent the protocol from completing. The trustless zero-knowledge randomization and distribution system may support voluntary departure by participants between the shuffle phase and the partial decryption phase. A participant may choose to voluntarily depart from the protocol after the shuffling process has completed but before the partial decryption operations have been performed for all designated ciphertext slots. Voluntary departure may occur for various reasons, including participant unavailability, network connectivity issues, or application-level decisions to exit the protocol session.

When a participant voluntarily departs between the shuffle phase and the partial decryption phase, the departing participant may be required to pre-strip the decryption layers of the departing participant from all dealt slots before the remaining quorum can complete the protocol. During the shuffling process, the departing participant may have applied an encryption layer to the dataset using the cryptographic keys of the departing participant. The encrypted data items stored on-chain after the shuffling process may contain an encryption layer corresponding to the encryption applied by the departing participant. To enable the remaining participants to complete the partial decryption operations without dependency on the departing participant, the departing participant may remove the encryption layer of the departing participant from each ciphertext slot that has been dealt or designated for distribution.

The pre-stripping operation may comprise a partial decryption operation performed by the departing participant for each dealt slot. For each dealt slot, the departing participant may fetch the current ciphertext for the slot and may compute a layer-stripped ciphertext by applying a partial decryption operation using the private key of the departing participant. The departing participant may generate a zero-knowledge proof demonstrating that the partial decryption operation was performed correctly. The departing participant may submit the layer-stripped ciphertext and the zero-knowledge proof to the on-chain contract for each dealt slot.

The on-chain contract may verify each zero-knowledge proof submitted by the departing participant and may update the stored ciphertext references for the dealt slots upon successful verification. After the departing participant has pre-stripped the decryption layers from all dealt slots, the ciphertexts for the dealt slots may no longer contain an encryption layer corresponding to the departing participant. The remaining participants may then perform partial decryption operations on the updated ciphertexts without requiring further cooperation from the departing participant.

The pre-stripping requirement may provide that the departing participant removes the encryption contribution of the departing participant before departure, enabling the protocol to continue with the remaining quorum. The remaining quorum may comprise the participants who have not departed from the protocol session. After the departing participant has completed the pre-stripping operations, the remaining quorum may complete the partial decryption operations for the dealt slots by each remaining participant removing the encryption layer corresponding to the encryption applied by that remaining participant during the shuffling process.

Following voluntary departure and completion of the pre-stripping operations, the protocol may continue with the remaining quorum of participants or may be gracefully aborted at the application's discretion. The on-chain component may notify the application of the participant departure, and the application may determine whether to continue the protocol with the reduced participant set or to abort the protocol session. In some implementations, the protocol may continue with the remaining participants if the remaining participants are sufficient to complete the randomization and distribution operations. In some implementations, the application may specify a minimum quorum size, and the protocol may abort if the number of remaining participants falls below the minimum quorum size after the voluntary departure.

The bias-resistance and soundness properties of the protocol may be preserved for the remaining quorum after voluntary departure. The contribution of the departing participant to the joint permutation during the shuffling process may be absorbed into the cumulative shuffle that was applied by all participants. The pre-stripping of decryption layers by the departing participant may remove the encryption contribution of the departing participant without affecting the permutation contribution. The residual partial-decryption chain performed by the remaining quorum may be validated by the on-chain verifier through zero-knowledge proof verification for each partial decryption step.

In some implementations, the on-chain contract may enforce a timeout for completion of the pre-stripping operations by the departing participant. If the departing participant fails to complete the pre-stripping operations within the timeout period, the on-chain contract may trigger an enforcement action. The enforcement action may comprise forfeiting the deposit of the departing participant and treating the departure as a non-voluntary dropout rather than a voluntary departure. The timeout enforcement may incentivize departing participants to complete the pre-stripping operations in a timely manner.

### Callback Architecture and Application Interface

In some implementations, applications built on top of the system receive notifications when protocol phases complete. The system uses a callback mechanism where the cryptographic components notify the application when operations like shuffling or dealing are finished. This allows the application to manage its own logic, such as game phases or betting rounds, separately from the cryptographic operations. The trustless zero-knowledge randomization and distribution system may employ a callback architecture that decouples cryptographic infrastructure from application-level state machines. The on-chain component may expose a nextToCall mapping that associates a game identifier or session identifier with a phase-completion callback address. The phase-completion callback may reference an application contract that receives notifications when cryptographic protocol phases complete.

The nextToCall mapping may store, for each game identifier, an address or function selector indicating the application contract function to invoke upon completion of a cryptographic protocol phase. When the on-chain component completes a protocol phase, such as registration, shuffling, dealing, or reveal, the on-chain component may invoke the callback function specified in the nextToCall mapping for the corresponding game identifier. The callback invocation may notify the application contract that the cryptographic protocol phase has completed and that the application may proceed with application-level logic.

The callback architecture may decouple cryptographic-infrastructure phase transitions from application-level state machines. Cryptographic-infrastructure phase transitions may include transitions between registration, shuffle, deal, and reveal phases of the randomization and distribution protocol. Application-level state machines may include game phases in gaming applications, betting rounds in poker applications, bid windows in auction applications, or other application-specific state progressions. The decoupling may allow the cryptographic infrastructure to operate independently of application-specific logic, with the application contract receiving notifications through the callback mechanism when cryptographic operations complete.

In some implementations, a Texas Hold'em poker implementation may use the callback architecture to drive application-level state transitions. The Texas Hold'em implementation may comprise multiple modules including a factory module, a table module, an evaluator module, a game-logic module, and a betting-action module. The application contract may register callback functions with the on-chain component through the nextToCall mapping.

After the on-chain component completes dealing operations, the on-chain component may invoke a start callback function on the application contract. The start callback may signal to the application contract that initial cards have been dealt and that the game may begin. The application contract may respond to the start callback by transitioning the game state to an active state and enabling player actions such as betting.

After each betting round completes, the on-chain component may invoke a resume callback function on the application contract. The resume callback may signal to the application contract that a betting round has concluded and that the game may proceed to a subsequent phase. In Texas Hold'em poker, the resume callback may trigger transitions between pre-flop, flop, turn, and river phases. The application contract may respond to the resume callback by initiating the dealing of community cards or by transitioning to a showdown phase.

The callback architecture may support various application types beyond gaming applications. An auction application may use the callback architecture to receive notifications when bid shuffling completes or when bid values are revealed. A sortition application may use the callback architecture to receive notifications when candidate shuffling completes or when selected candidates are revealed. Each application type may register application-specific callback functions with the on-chain component, and the on-chain component may invoke the registered callbacks upon completion of the corresponding cryptographic protocol phases.

The callback architecture may allow the on-chain component to remain application-agnostic. The on-chain component may perform cryptographic operations including proof verification, state updates, and phase tracking without incorporating application-specific logic. Application-specific logic may reside in the application contract, which receives phase-completion notifications through the callback mechanism. The separation of cryptographic infrastructure from application logic may allow the on-chain component to be reused across multiple application types without modification.

In some implementations, the application contract may update the nextToCall mapping to specify different callback functions for different protocol phases. The application contract may register a first callback function to be invoked after dealing operations and a second callback function to be invoked after reveal operations. The on-chain component may read the nextToCall mapping at the completion of each protocol phase and may invoke the callback function specified for that phase. The dynamic registration of callback functions may allow application contracts to customize the notification behavior based on application requirements.

### Implementation Components

The trustless zero-knowledge randomization and distribution system may be implemented using various smart contract platforms and programming languages. In some implementations, the on-chain components may be deployed on blockchain platforms that support smart contract execution and provide precompiled contracts or native support for cryptographic operations used in zero-knowledge proof verification. The selection of a smart contract platform may depend on factors including the availability of cryptographic primitives, gas costs for proof verification operations, and compatibility with the elliptic curves and proof systems employed by the protocol.

The on-chain implementation may comprise one or more smart contracts that collectively provide the functionality of the on-chain components. A coordinator contract or set of contracts may manage protocol state, store references to participant credentials, track protocol phases, and verify zero-knowledge proofs submitted by participants. The smart contracts may be implemented in programming languages supported by the target blockchain platform, and the implementation may utilize libraries or modules that provide cryptographic operations, data structure utilities, and other functionality used by the protocol.

The on-chain implementation may include libraries or modules for elliptic curve operations on the curve used for encryption. The elliptic curve operations may include point addition, scalar multiplication, and other group operations. The libraries may provide functions for deriving public keys from private keys, verifying curve point membership, and performing the elliptic curve operations used in encryption and decryption. The specific curve and operations may vary depending on the cryptographic primitives selected for the implementation.

The on-chain implementation may include libraries or modules for data compression and efficient storage. Data compression techniques may reduce on-chain storage requirements and transaction calldata costs. Compressed representations of cryptographic data, such as curve points, may store a subset of the data along with auxiliary information sufficient to recover the full data. The compression may reduce storage costs relative to uncompressed representations, potentially at the cost of additional computation during data recovery.

The on-chain implementation may include data structures for efficiently tracking the state of data items in a collection. Bitmap data structures or similar compact representations may track which items have been processed, which items remain pending, and which items have been revealed. Compact state tracking may reduce storage costs relative to alternative data structures that store individual status values for each item.

The off-chain implementation may comprise software modules that perform cryptographic operations, generate zero-knowledge proofs, and interact with the on-chain components. The off-chain software may be implemented in programming languages suitable for cryptographic computation and may utilize libraries or frameworks that provide zero-knowledge proof generation capabilities. The off-chain software may execute on computing devices controlled by participants and may communicate with blockchain nodes to submit transactions and retrieve on-chain state.

The zero-knowledge proof relations used by the system may be defined using circuit description languages or frameworks suitable for the selected proof system. Circuit description languages may allow developers to specify the constraints that a valid witness must satisfy for a given proof relation. The circuit definitions may be compiled to intermediate representations, such as constraint systems, that are used by proof generation and verification algorithms. The compilation process may produce artifacts used for proof generation by off-chain components and proof verification by on-chain components.

The proof verification logic deployed on-chain may be generated from the circuit definitions and proof system parameters. Automated generation of verification logic from circuit definitions may reduce the risk of implementation errors in the verification code. The generated verification logic may utilize cryptographic primitives provided by the blockchain platform, such as precompiled contracts for pairing operations or other cryptographic functions. The verification logic may accept proofs and public inputs as parameters and may return a result indicating whether the proof is valid for the given inputs.

The modular architecture of the implementation may allow components to be substituted or upgraded without requiring changes to other components. The on-chain coordinator contract may expose interfaces that application contracts implement to receive notifications of protocol events. The decoupling of cryptographic infrastructure from application-specific logic may allow the coordinator contract to be reused across multiple application types. Similarly, the off-chain components may be structured to allow substitution of cryptographic libraries, proof systems, or communication mechanisms without requiring changes to the overall software architecture.

In some implementations, the trustless zero-knowledge randomization and distribution system may be implemented using, for example, Solidity smart contracts and associated libraries deployed on Ethereum Virtual Machine (EVM) compatible blockchain platforms. A reference implementation may comprise a Solidity coordinator contract that serves as the on-chain component for managing protocol state, verifying proofs, and coordinating participant interactions.

The Solidity implementation may include a library for BabyJubJub curve operations. The BabyJubJub curve operations library may implement elliptic curve point addition, scalar multiplication, and other group operations on the BabyJubJub twisted Edwards curve. The library may provide functions for computing public keys from private keys through scalar multiplication of the generator. The library may also provide functions for verifying curve point membership and for performing the elliptic curve operations used in ElGamal encryption and decryption.

The Solidity implementation may include a library for deck operations with compression and bitmap utilities. The deck operations library may implement compression functions for representing curve points in a compressed format. The compressed point representation may store each curve point as a tuple comprising an x-coordinate field element, a y-sign selector bit, and a small auxiliary value used in a recovery relation. The compression may reduce on-chain storage and calldata requirements by approximately 50% relative to uncompressed representations where both x and y coordinates are stored in full. The deck operations library may also include bitmap utilities for tracking the state of data items in a collection, such as tracking which items have been dealt, which items remain in the collection, and which items have been revealed.

The Solidity implementation may include a library for efficient slot tracking via bitmaps. The bitmap library may implement data structures and functions for tracking the status of ciphertext slots in the shuffled dataset. Each bit in a bitmap may correspond to a slot in the dataset, with the bit value indicating a status condition for the corresponding slot. The bitmap library may provide functions for setting bits, clearing bits, and querying bit values. The bitmap library may also provide functions for counting set bits, finding the first set bit, and iterating over set bits. The use of bitmaps for slot tracking may reduce storage costs relative to alternative data structures, as multiple slot status values may be packed into a single storage word.

The coordinator contract may serve as the on-chain component that manages the protocol state and coordinates participant interactions. The coordinator contract may store references to participant public keys, track the current protocol phase, maintain references to encrypted data states, and verify zero-knowledge proofs submitted by participants. The coordinator contract may enforce deterministic turn ordering during shuffling phases and may enforce timeout requirements for participant actions. The coordinator contract may also manage security deposits and may trigger deposit forfeiture when participants fail to act within timeout periods or submit invalid proofs.

The coordinator contract may expose an interface for application contracts to interact with the cryptographic infrastructure. The interface may define callback functions that the coordinator contract invokes upon completion of protocol phases. Application contracts may implement the interface to receive notifications when registration completes, when shuffling completes, when dealing operations complete, and when reveal operations complete. The interface may decouple the cryptographic infrastructure from application-specific logic, allowing the coordinator contract to be reused across multiple application types.

In some implementations, the trustless zero-knowledge randomization and distribution system may use Circom circuits for defining the zero-knowledge proof relations. Circom may be a domain-specific language for defining arithmetic circuits used in zero-knowledge proof systems. Circuits defined in Circom may be compiled to Rank-1 Constraint System (R1CS) representations. The R1CS representation may encode the constraints that a valid witness satisfies for a given circuit.

A shuffle circuit defined in Circom may encode the constraints for verifying shuffle-and-re-encrypt operations. The shuffle circuit may verify that a permutation matrix is valid, that output ciphertexts correspond to re-randomized permutations of input ciphertexts, and that public inputs are correctly committed via hashing. The shuffle circuit may be compiled to an R1CS representation that encodes the constraints for the shuffle relation.

A partial decryption circuit defined in Circom may encode the constraints for verifying partial decryption operations. The partial decryption circuit may verify that a participant correctly removed an encryption layer using the participant's private key, without revealing the private key. The partial decryption circuit may verify that the public key of the participant equals the scalar multiplication of the generator by the private key, and that the updated ciphertext component equals the original ciphertext component minus the scalar multiplication of the first ciphertext component by the private key.

The Circom circuits may be compiled to snarkjs-generated Groth16 verifier contracts. The snarkjs tool may generate Solidity smart contract code that implements the Groth16 verification algorithm for a specific circuit. The generated verifier contracts may be deployed on EVM-compatible blockchain platforms. The generated verifier contracts may use the alt-bn128 pairing precompiles specified in EIP-196 and EIP-197 to perform pairing operations during proof verification. The mechanical generation of verifier contracts from the structured reference string may reduce the risk of implementation errors in the verification logic.

### Sybil Resistance and Economic Security

The trustless zero-knowledge randomization and distribution system may address Sybil attack vulnerabilities. A Sybil attack may occur when a single real-world entity controls multiple keypairs and registers multiple distinct keypairs as different participants in the protocol. A single entity controlling multiple keypairs may effectively reduce the number of independent participants contributing randomness to the joint permutation. The bias-resistance property of the protocol may assume 1-of-n honesty over distinct participants, and a Sybil attacker controlling multiple participant slots may reduce the effective value of n for purposes of the honesty assumption.

The system may mitigate Sybil attacks economically through per-seat deposits. Each participant may post a security deposit at registration, and the security deposit may be held by the on-chain component as collateral. The per-seat deposit requirement may raise the cost of multi-seat occupation by a single entity. An entity seeking to control multiple participant slots may be required to post a separate security deposit for each participant slot controlled by the entity. The aggregate deposit requirement for controlling multiple slots may increase linearly with the number of slots, creating an economic barrier to Sybil attacks. The economic cost of occupying multiple seats may deter entities from attempting to control a large fraction of the participant set.

The per-seat deposit mechanism may provide economic enforcement of participant diversity without requiring cryptographic proof of distinct identity. The economic mitigation through per-seat deposits may be layered above the cryptographic security properties of the protocol.

In some implementations, the system may integrate stake-weighted aggregation for enhanced Sybil resistance. Stake-weighted aggregation may weight the contribution of each participant according to the stake deposited by the participant. Participants who deposit larger stakes may have greater influence on the randomization outcome, and the cost of biasing the outcome may scale with the total stake of honest participants. Stake-weighted aggregation may increase the economic cost for an attacker to achieve a given level of influence over the randomization outcome.

In some implementations, the system may integrate anonymous-credential-based proof-of-personhood for enhanced Sybil resistance. Proof-of-personhood mechanisms may provide cryptographic or procedural verification that each participant corresponds to a distinct real-world individual. Anonymous credentials may allow participants to demonstrate proof-of-personhood without revealing identifying information. The integration of proof-of-personhood mechanisms may provide stronger assurance of participant distinctness than economic mechanisms alone.

The integration of stake-weighted aggregation or anonymous-credential-based proof-of-personhood may add dependencies and trust assumptions to the system. Stake-weighted aggregation may introduce dependencies on stake measurement and may alter the trust model by weighting participant contributions unequally. Anonymous-credential-based proof-of-personhood may introduce dependencies on credential issuers and may require trust in the credential issuance process. The selection of Sybil resistance mechanisms may involve trade-offs between the strength of Sybil resistance, the complexity of the system, and the trust assumptions introduced by the selected mechanisms.

In some implementations, the system may integrate external Sybil resistance mechanisms including know-your-customer (KYC) verification, allowlist deployment in regulated environments, or other identity verification approaches. External Sybil resistance mechanisms may be applied at the application layer and may complement the economic Sybil resistance provided by per-seat deposits. The combination of economic mechanisms and external verification mechanisms may provide layered Sybil resistance appropriate for different deployment contexts and regulatory environments.

### Post-Quantum Considerations and Migration Paths

The trustless zero-knowledge randomization and distribution system may support post-quantum migration paths to address potential vulnerabilities arising from advances in quantum computing. The cryptographic primitives employed in the system, including ElGamal encryption on the BabyJubJub curve and Groth16 zero-knowledge proofs, may rely on hardness assumptions that may be vulnerable to quantum adversaries with access to large-scale quantum computers. Post-quantum migration paths may enable the system to transition to quantum-resistant cryptographic primitives while preserving the protocol structure.

In some implementations, lattice-based partial-homomorphic encryption may serve as a post-quantum alternative to ElGamal encryption. Lattice-based encryption schemes may derive security from the hardness of lattice problems, such as the Learning With Errors (LWE) problem or the Ring Learning With Errors (Ring-LWE) problem. Lattice problems may be believed to be resistant to attacks by quantum computers. Lattice-based partial-homomorphic encryption may support the additive homomorphic properties used in the re-randomization operations of the shuffling process. The substitution of lattice-based partial-homomorphic encryption for ElGamal encryption may preserve the shuffle-and-re-encrypt construction while providing resistance to quantum adversaries.

In some implementations, STARK-based zero-knowledge proof systems may serve as a post-quantum alternative to Groth16 zero-knowledge proofs. STARK (Scalable Transparent Argument of Knowledge) proof systems may provide zero-knowledge proofs without requiring a trusted setup ceremony. STARK proof systems may derive security from collision-resistant hash functions rather than from elliptic curve pairings or discrete logarithm assumptions. Hash-based security assumptions may be believed to be resistant to attacks by quantum computers. STARK-based proof systems may produce larger proofs than Groth16 proofs, and verification costs may differ from Groth16 verification costs. The substitution of STARK-based proof systems for Groth16 may preserve the per-step zero-knowledge verification structure while providing resistance to quantum adversaries.

In some implementations, lattice-based SNARKs may serve as a post-quantum alternative to Groth16 zero-knowledge proofs. Lattice-based SNARKs may derive security from lattice hardness assumptions and may provide succinct proofs with efficient verification. Lattice-based SNARKs may combine the succinctness properties of SNARK proof systems with the quantum resistance properties of lattice-based cryptography. The substitution of lattice-based SNARKs for Groth16 may preserve the constant-size proof and efficient verification characteristics while providing resistance to quantum adversaries.

In some implementations, hash-based commitments may serve as a post-quantum alternative to Pedersen-style commitments used within zero-knowledge circuits. Hash-based commitments may derive security from the collision resistance and preimage resistance of cryptographic hash functions. Hash-based commitments may bind proofs to specific public inputs without relying on discrete logarithm assumptions. The substitution of hash-based commitments for Pedersen-style commitments may preserve the binding property used to prevent input-substitution attacks while providing resistance to quantum adversaries.

The protocol structure of the trustless zero-knowledge randomization and distribution system may be preserved across primitive substitutions. The protocol structure may comprise sequential per-participant shuffle-and-re-encrypt operations, layered partial decryption, per-step zero-knowledge proofs, and on-chain verification. The substitution of post-quantum cryptographic primitives may replace the underlying encryption schemes, proof systems, and commitment schemes without altering the protocol structure. The key setup phase, state initialization phase, sequential shuffle operation phase, partial decryption phase, and final validation phase may proceed according to the same protocol flow with post-quantum primitives substituted for the corresponding pre-quantum primitives.

The 1-of-n honesty assumption for bias-resistance may be preserved across primitive substitutions. The bias-resistance property may depend on the semantic security of the encryption scheme and the soundness of the zero-knowledge proof system. Post-quantum encryption schemes providing semantic security under quantum adversaries and post-quantum proof systems providing soundness under quantum adversaries may preserve the bias-resistance property of the protocol. The joint permutation resulting from sequential shuffling operations may remain computationally indistinguishable from a uniformly random permutation under post-quantum security assumptions if at least one participant is honest.

The selective information disclosure capabilities of the system may be preserved across primitive substitutions. The layered partial decryption structure may operate with post-quantum encryption schemes that support the removal of encryption layers by individual participants. The privacy of plaintext data items intended for designated recipients may be maintained under post-quantum security assumptions. The consistency proofs for public reveals may be generated using post-quantum proof systems while preserving the verification of correspondence between revealed plaintext and recorded ciphertext.

Post-quantum migration paths may not be implemented in the current system. The current system may employ ElGamal encryption on the BabyJubJub curve, Groth16 zero-knowledge proofs, and Pedersen or Poseidon hashing for commitments. The post-quantum migration paths described herein may represent alternative implementations that may be deployed in future versions of the system or in deployments where quantum resistance is a deployment requirement. The modular architecture of the protocol structure may facilitate the substitution of cryptographic primitives without requiring redesign of the protocol flow or the on-chain verification logic.

### Examples

### Card Games

In some implementations, the trustless zero-knowledge randomization and distribution system may be applied to mental poker and card game applications. Mental poker refers to cryptographic protocols that enable two or more parties to deal cards from a shared deck without a trusted dealer. The system may implement mental poker protocols using the distributed encryption, zero-knowledge proof verification, and selective disclosure capabilities described herein.

In a mental poker application, the collection to be randomized may comprise a 52-card deck. Each card in the 52-card deck may be encoded to a fixed BabyJubJub curve point using a deterministic encoding function. The encoding function may map each card to a corresponding curve point in the prime-order group on the BabyJubJub twisted Edwards curve. The encoding may be deterministic such that each card maps to a predefined curve point, and the set of 52 curve points corresponding to the 52 cards may be publicly known to all participants.

During the state initialization phase for a mental poker application, the 52-card deck may be placed on-chain in encrypted form. Each card may be encrypted under the aggregated public key derived from the individual public keys of the participating players. Because the encoding rule mapping cards to curve points is publicly known, the initial encrypted state may be computed deterministically from the encoding rule and a public seed. Any verifier may recompute the initial encrypted state independently, and the on-chain contract may verify the correctness of the initial encrypted state by recomputation.

Players in the mental poker application may serve as participants in the randomization and distribution protocol. Each player may generate a private key off-chain and may register public credentials with the on-chain contract during the key setup phase. The players may perform sequential shuffling operations during the shuffle phase, with each player applying a random permutation and re-encryption to the encrypted deck. Each shuffling operation may be accompanied by a zero-knowledge proof demonstrating that the shuffling operation was performed correctly.

The system may implement differentiated handling of hole cards and community cards during the partial decryption phase. Hole cards and community cards may have different disclosure requirements in poker games. Hole cards may be intended to remain private to the player who receives the hole cards, while community cards may be intended to be revealed publicly to all players at designated times during gameplay.

When a hole card is dealt to a player, the partial decryption sequence may be structured such that the designated player is the last participant in the decryption sequence. The other players may perform partial decryption operations to remove the encryption layers corresponding to the encryption applied by the other players during the shuffling process. Each player who is not the designated recipient may remove the encryption layer of that player from the ciphertext corresponding to the hole card. After all non-recipient players have performed partial decryption operations, the residual ciphertext may remain encrypted under the encryption layer of the designated recipient.

The designated recipient may recover the plaintext card value locally by applying the final partial decryption operation using the private key of the designated recipient. The designated recipient may obtain the plaintext card value and may view the card privately without revealing the card value to other players. Other players who performed partial decryption operations earlier in the sequence may not have access to the final plaintext, as the card may remain encrypted under the encryption layer of the designated recipient until the designated recipient performs the final decryption.

When a community card is to be revealed, the partial decryption sequence may terminate with public posting of the plaintext card value. All players may perform partial decryption operations to remove the encryption layers corresponding to the encryption applied by all players during the shuffling process. After all players have performed partial decryption operations, the participant who completes the final decryption may post the plaintext card value along with a consistency proof. The consistency proof may demonstrate that the revealed card value corresponds to the ciphertext that was recorded on-chain after the shuffling process. All players may observe the revealed community card, and the on-chain proof verification may confirm that the revealed card corresponds to the ciphertext that was recorded on-chain.

In Texas Hold'em poker applications, each player may receive two hole cards that are visible to that player but hidden from other players. Community cards may be dealt face-down initially and revealed to all players at designated points during the hand, such as the flop, turn, and river phases. The flop phase may involve revealing three community cards, the turn phase may involve revealing one additional community card, and the river phase may involve revealing one additional community card. The system may implement the selective disclosure requirements of Texas Hold'em through the differentiated handling of hole cards and community cards during the partial decryption phase.

The mental poker application may operate without a trusted dealer. No single party may control the shuffling of the deck or the dealing of cards. Each player may contribute randomness to the joint permutation through the shuffling operation performed by that player. The random permutation applied by each player may be generated using local entropy sources on the computing device of that player. The combination of multiple players each contributing randomness through local permutation and encryption operations may result in collective randomness that no single player can control or predict.

The mental poker application may operate without a trusted random number generator (RNG) oracle. No centralized random oracle may be used to generate or provide random values for the shuffling process. Each player may generate randomness locally, and the randomness contribution of each player may be validated by zero-knowledge proofs submitted to the on-chain contract. The elimination of reliance on a trusted RNG oracle may remove a potential point of manipulation or failure from the card game application.

The mental poker application may achieve bias-resistance under a 1-of-n honesty assumption, where n is the number of players. Under the 1-of-n honesty assumption, the joint permutation resulting from sequential shuffling operations by n players may be computationally indistinguishable from a uniformly random permutation if at least one player of the n players is honest. The contribution of an honest player may prevent other players from predicting or biasing the final permutation of the deck. Even if n−1 players collude to attempt to bias the shuffle, the permutation and re-randomization values contributed by the single honest player may randomize the deck such that the colluding players cannot predict or control the final card ordering.

The zero-knowledge proofs verified on-chain may provide cryptographic assurance that each shuffling operation was performed correctly, without revealing the specific permutations applied by each player. Players may verify that the deck was shuffled correctly based on the cryptographic proofs, without gaining information about the specific permutation applied by any other player. The privacy of shuffle methods may be maintained throughout the shuffling process, preventing players from gaining information about the card ordering that could be used to gain an advantage during gameplay.

### Sealed-Bid Auctions

In some implementations, the trustless zero-knowledge randomization and distribution system may be applied to sealed-bid auction applications. Sealed-bid auctions may involve multiple bidders submitting bids that are intended to remain confidential until a designated revelation time. The system may address vulnerabilities present in conventional sealed-bid auction designs by using encrypted bids as the collection to be shuffled and by opening bids in a verifiable random order.

In a sealed-bid auction application, each bidder may submit a bid value that is encrypted under the aggregated public key derived from the individual public keys of the auction participants. The encrypted bids may form the collection to be randomized. Each bid may be encoded to a curve point in the prime-order group using an application-specific encoding function. The encoding function may map bid values to corresponding curve points according to a predefined mapping rule.

During the state initialization phase for a sealed-bid auction application, each bidder may generate a ciphertext by encrypting the bid value using ElGamal encryption under the aggregated public key. Each bidder may sample randomness locally and compute the ciphertext as a pair of group elements. The ciphertext may be submitted to the on-chain contract for inclusion in the bid collection.

Each bidder may generate a per-contribution proof of well-formedness when submitting an encrypted bid. The per-contribution proof of well-formedness may demonstrate that the bid value belongs to a permitted set of valid bid values. The permitted set may comprise bid values within a valid range or bid values that satisfy application-specific constraints defined by the auction parameters. The per-contribution proof of well-formedness may be a zero-knowledge proof that demonstrates the bid value belongs to the permitted set without revealing the specific bid value. The on-chain contract may verify each per-contribution proof of well-formedness before accepting the encrypted bid into the bid collection.

After the bidding period concludes, the auction participants may perform sequential shuffling operations on the encrypted bid collection. Each participant may acquire the current encrypted bid data from the on-chain contract, apply a random permutation to the encrypted bids, apply re-encryption to the permuted bids to produce updated encrypted data, and generate a zero-knowledge proof demonstrating that the shuffling operation was performed correctly. The shuffling operations may randomize the ordering of the encrypted bids such that the correspondence between bidder identities and bid positions in the shuffled collection is obscured.

Following the shuffling phase, the encrypted bids may be opened in a verifiable random order through sequential partial decryption operations. The participants may perform partial decryption operations to remove encryption layers from the shuffled bid ciphertexts. The order in which bids are revealed may correspond to the randomized ordering established during the shuffling phase. Each revealed bid value may be posted publicly along with a consistency proof demonstrating that the revealed value corresponds to the ciphertext that was recorded on-chain.

The verifiable random opening order may defeat opening-order strategic attacks. In conventional sealed-bid auction designs, an auctioneer or other party controlling the bid opening process may selectively delay reveals to gain strategic advantage. The auctioneer may observe partially revealed bid information and use the observed information to influence subsequent reveal decisions. By shuffling the encrypted bids before opening and revealing bids in the randomized order, the system may prevent any party from controlling or predicting the order in which bids are revealed.

The system may also defeat last-bidder timing manipulation. In conventional commit-reveal sealed-bid auction designs, a participant who is the last to reveal may observe all other revealed values and compute the resulting outcome before deciding whether to reveal. If the computed outcome is unfavorable, the last-revealing participant may choose to withhold the reveal, causing the auction to abort or default to an alternative outcome. The shuffling of encrypted bids before opening may randomize the reveal order such that no participant may position as the last revealer with knowledge of other bid values.

Commit-reveal sealed-bid auction designs may use commitments without a verifiable mix. In commit-reveal designs, each bidder may generate a secret bid value, compute a hash of the bid value, and publish the hash as a commitment. After all bidders have published commitments, bidders may reveal their bid values. Commit-reveal designs may be susceptible to last-revealer manipulation and front-running attacks in blockchain environments. A bidder may observe another bidder's reveal transaction in a mempool and submit a transaction with a higher gas price to have the observing bidder's reveal processed first.

The verifiable-mix approach employed by the trustless zero-knowledge randomization and distribution system may provide cryptographic properties that address the vulnerabilities of commit-reveal designs. The shuffling of encrypted bids may break the link between bidder identities and bid positions in the reveal sequence. The zero-knowledge proofs accompanying each shuffling operation may provide cryptographic assurance that the shuffling was performed correctly without revealing the permutation applied. The randomized reveal order may prevent strategic manipulation based on reveal timing or reveal ordering.

The system may achieve bias-resistance under a 1-of-n honesty assumption in the sealed-bid auction context. Under the 1-of-n honesty assumption, the joint permutation resulting from sequential shuffling operations by n participants may be computationally indistinguishable from a uniformly random permutation if at least one participant of the n participants is honest. The contribution of an honest participant may prevent other participants from predicting or biasing the final ordering of the bid collection. Even if n-1 participants collude to attempt to bias the shuffle, the permutation and re-randomization values contributed by the single honest participant may randomize the bid ordering such that the colluding participants cannot predict or control the reveal sequence.

In some implementations, the participant set for a sealed-bid auction may be shuffled to randomize bidder identity order. The shuffling of the participant set may be applied in Vickrey-style auctions where allocation among ties may depend on bidder ordering. By randomizing the bidder identity order, the system may prevent any party from influencing tie-breaking outcomes based on bidder positioning.

The on-chain contract may gate partial-decryption transactions for bid reveals on a wall-clock time predicate. The wall-clock time predicate may specify that bid values may be revealed after a designated auction closing time. The on-chain contract may compare the current block timestamp or an external time reference against the predicate condition and may accept partial-decryption transactions when the time condition is satisfied. The time-gated reveal mechanism may enforce that all bids remain confidential until the designated auction closing time.

The sealed-bid auction application may operate without a trusted auctioneer for the bid opening process. No single party may control the ordering of bid reveals or the timing of individual bid revelations. Each participant may contribute randomness to the joint permutation through the shuffling operation performed by that participant. The combination of multiple participants each contributing randomness through local permutation and encryption operations may result in collective randomness that no single participant can control or predict.

The zero-knowledge proofs verified on-chain may provide cryptographic assurance that each shuffling operation was performed correctly, without revealing the specific permutations applied by each participant. Auction participants may verify that the bid collection was shuffled correctly based on the cryptographic proofs, without gaining information about the specific permutation applied by any other participant. The privacy of shuffle methods may be maintained throughout the shuffling process, preventing participants from gaining information about the bid ordering that could be used to gain an advantage during the reveal phase.

### Federated Voting

In some implementations, the trustless zero-knowledge randomization and distribution system may be applied to federated voting applications as a verifiable mix-net. A verifiable mix-net may provide a mechanism for shuffling encrypted data items such that the correspondence between input items and output items is obscured while maintaining cryptographic verifiability that the shuffling was performed correctly. In federated voting applications, the verifiable mix-net may shuffle encrypted ballots to break the link between voter identities and ballot contents while enabling public verification of the shuffling process.

In a federated voting application, encrypted ballots may form the collection to be randomized. Each voter may cast a ballot by encrypting the ballot contents under an aggregated public key derived from the individual public keys of a set of trustees. The encrypted ballot may be submitted to an on-chain contract for inclusion in the ballot collection. Each encrypted ballot may comprise a ciphertext that encodes the voter's selection without revealing the selection to observers of the blockchain.

A board of trustees may play the role of the participant set in the federated voting application. The board of trustees may comprise multiple parties with an interest in the integrity of the voting process. Each trustee may generate a private key off-chain and may register public credentials with the on-chain contract during a key setup phase. The aggregated public key used for ballot encryption may be derived from the individual public keys of the trustees. The distribution of encryption authority among multiple trustees may provide that no single trustee may decrypt individual ballots without the cooperation of other trustees.

During a ballot collection phase, voters may submit encrypted ballots to the on-chain contract. Each voter may encrypt the ballot contents using ElGamal encryption under the aggregated public key of the board of trustees. The voter may sample randomness locally and compute the ciphertext as a pair of group elements. The on-chain contract may record each encrypted ballot as a ciphertext reference. The encrypted ballots may accumulate on-chain during the ballot collection phase without revealing the contents of individual ballots.

In some implementations, each voter may generate a per-contribution proof of well-formedness when submitting an encrypted ballot. The per-contribution proof of well-formedness may demonstrate that the ballot contents belong to a permitted set of valid ballot options. The permitted set may comprise the valid candidates or choices available in the election. The per-contribution proof of well-formedness may be a zero-knowledge proof that demonstrates the ballot contents belong to the permitted set without revealing the specific ballot selection. The on-chain contract may verify each per-contribution proof of well-formedness before accepting the encrypted ballot into the ballot collection.

After the ballot collection phase concludes, the board of trustees may perform a joint mix of the encrypted ballots through sequential shuffling operations. Each trustee may acquire the current encrypted ballot data from the on-chain contract, apply a random permutation to the encrypted ballots, apply re-encryption to the permuted ballots to produce updated encrypted data, and generate a zero-knowledge proof demonstrating that the shuffling operation was performed correctly. The shuffling operations may randomize the ordering of the encrypted ballots such that the correspondence between voter submission order and shuffled ballot positions is obscured.

The joint mix may comprise sequential shuffling operations performed by each trustee in a deterministic turn order. A first trustee may perform a shuffling operation on the initial encrypted ballot collection and may submit the updated encrypted data and a zero-knowledge proof to the on-chain contract. The on-chain contract may verify the zero-knowledge proof and may update the stored data references upon successful verification. A second trustee may then acquire the updated encrypted ballot data and may perform a subsequent shuffling operation. The process may continue with additional trustees, with each trustee contributing randomness through local permutation and re-encryption operations.

After the joint mix is complete, the mixed ballots may be publicly revealed for tally. The trustees may perform sequential partial decryption operations to remove the encryption layers from the shuffled ballot ciphertexts. Each trustee may remove the encryption layer corresponding to the encryption applied by that trustee during the shuffling process. After all trustees have performed partial decryption operations for a ballot slot, the participant who completes the final decryption may post the plaintext ballot contents along with a consistency proof. The consistency proof may demonstrate that the revealed ballot contents correspond to the ciphertext that was recorded on-chain after the joint mix.

The public reveal of mixed ballots may enable tallying of the election results. Because the ballots have been shuffled through the joint mix, the correspondence between voter identities and revealed ballot contents may be obscured. Observers may view the revealed ballot contents and may verify the tally, but observers may not be able to determine which voter cast which ballot. The shuffling of ballots before reveal may maintain ballot privacy while enabling public verification of the election results.

The federated voting application may achieve bias-resistance under a 1-of-n honesty assumption across the board of trustees. Under the 1-of-n honesty assumption, the joint permutation resulting from sequential shuffling operations by n trustees may be computationally indistinguishable from a uniformly random permutation if at least one trustee of the n trustees is honest. The contribution of an honest trustee may prevent other trustees from predicting or controlling the correspondence between input ballot positions and output ballot positions after the joint mix.

The zero-knowledge proofs verified on-chain may provide cryptographic assurance that each shuffling operation was performed correctly, without revealing the specific permutations applied by each trustee. Trustees and external observers may verify that the ballot collection was shuffled correctly based on the cryptographic proofs, without gaining information about the specific permutation applied by any trustee. The privacy of shuffle methods may be maintained throughout the shuffling process, preventing any party from determining the mapping between voter submission order and shuffled ballot positions.

The federated voting application may operate without reliance on a single trusted party for ballot mixing. Each trustee may contribute randomness to the joint permutation through the shuffling operation performed by that trustee. No single trustee may hold a key or capability that provides unilateral control over the ballot ordering after the joint mix. The distribution of mixing authority among multiple trustees may reduce the risk that any single party may manipulate the ballot ordering or compromise ballot privacy.

In some implementations, the federated voting application may be deployed in consortium governance settings or decentralized autonomous organization (DAO) governance settings where on-chain verification is a deployment requirement. The on-chain verification of zero-knowledge proofs may provide a verifiable record of the mixing process that is recorded on the blockchain. The on-chain record may be audited by interested parties to verify that the mixing process was performed correctly according to the protocol requirements.

### Anti-MEV Ordering

In some implementations, the trustless zero-knowledge randomization and distribution system may be applied to anti-MEV (Maximal Extractable Value) transaction ordering applications. MEV refers to the value that may be extracted by parties who control transaction ordering within a block or batch. Parties controlling transaction ordering may engage in front-running, sandwich attacks, or other ordering manipulations to extract value from pending transactions. The system may address MEV concerns by providing verifiable randomization of transaction ordering such that no single party may control or predict the final transaction sequence.

In an anti-MEV transaction ordering application, a batch of pending transactions within a block window may be treated as the collection to be randomized. Each transaction in the batch may be encoded as a data item in the collection. The transactions may be encrypted under an aggregated public key derived from the individual public keys of a set of validators or a proposer set. The encrypted transactions may form the input to the shuffling process.

Validators or a proposer set may play the role of the participant set in the anti-MEV transaction ordering application. Each validator may generate a private key off-chain and may register public credentials with an on-chain contract during a key setup phase. The validators may perform sequential shuffling operations on the encrypted transaction batch. Each validator may acquire the current encrypted transaction data from the on-chain contract, apply a random permutation to the encrypted transactions, apply re-encryption to the permuted transactions to produce updated encrypted data, and generate a zero-knowledge proof demonstrating that the shuffling operation was performed correctly.

After the validators complete the sequential shuffling operations, the post-shuffle transaction order may be publicly revealed. The validators may perform partial decryption operations to remove encryption layers from the shuffled transaction ciphertexts. After all validators have performed partial decryption operations, the plaintext transaction ordering may be revealed and recorded on-chain. The revealed transaction ordering may then be used for transaction inclusion in a block or batch.

The trustless zero-knowledge randomization and distribution system may be applied to medium-batch regimes where prover latency is tolerable within the batch interval. Medium-batch regimes may include rollup-level batched ordering, hourly auctions, and scheduled block windows. In rollup-level batched ordering, a layer-2 rollup may accumulate transactions over a batch interval before submitting a batch to a layer-1 blockchain. The batch interval may provide sufficient time for validators to perform shuffling operations and generate zero-knowledge proofs. In hourly auctions, transactions may be accumulated over an hourly window before the transaction ordering is determined. The hourly batch interval may accommodate the proof generation time for the shuffling operations. In scheduled block windows, transactions may be accumulated during a scheduled window before block production, with the window duration providing time for the shuffling process.

The prover latency for shuffle proof generation may be tolerable within medium-batch intervals. Shuffle proof generation may take approximately 15-25 seconds for a collection of 52 items on commodity hardware. For medium-batch regimes with batch intervals measured in minutes or hours, the proof generation time may represent a small fraction of the batch interval. The bounded batch size in medium-batch regimes may limit the number of transactions to be shuffled, keeping the proof generation time within acceptable bounds.

The anti-MEV transaction ordering application may achieve bias-resistance under a 1-of-n honesty assumption across the validators or proposer set. Under the 1-of-n honesty assumption, the joint permutation resulting from sequential shuffling operations by n validators may be computationally indistinguishable from a uniformly random permutation if at least one validator of the n validators is honest. The contribution of an honest validator may prevent other validators from predicting or controlling the final transaction ordering. Even if n−1 validators collude to attempt to bias the shuffle, the permutation and re-randomization values contributed by the single honest validator may randomize the transaction ordering such that the colluding validators cannot predict or control the final sequence.

The verifiable randomization of transaction ordering may reduce the ability of any single party to engage in front-running or sandwich attacks based on transaction ordering control. Front-running attacks may involve observing a pending transaction and inserting a transaction ahead of the observed transaction to extract value. Sandwich attacks may involve inserting transactions both before and after a target transaction to extract value. By randomizing the transaction ordering through a multi-party shuffling process, the system may prevent any single party from positioning transactions to execute front-running or sandwich attacks.

The zero-knowledge proofs verified on-chain may provide cryptographic assurance that each shuffling operation was performed correctly, without revealing the specific permutations applied by each validator. Validators and external observers may verify that the transaction batch was shuffled correctly based on the cryptographic proofs, without gaining information about the specific permutation applied by any validator. The privacy of shuffle methods may be maintained throughout the shuffling process, preventing validators from gaining information about the transaction ordering that could be used to extract MEV.

The anti-MEV transaction ordering application may operate without reliance on a single trusted party for transaction ordering. Each validator may contribute randomness to the joint permutation through the shuffling operation performed by that validator. No single validator may hold a key or capability that provides unilateral control over the transaction ordering. The distribution of ordering authority among multiple validators may reduce the risk that any single party may manipulate transaction ordering for MEV extraction.

### Multi-Party Lottery

In some implementations, the trustless zero-knowledge randomization and distribution system may be applied to multi-party lottery applications or selection applications involving a large registry. Multi-party lottery applications may involve selecting one or more winners from a pool of participants through a randomization process. Selection applications involving a large registry may involve selecting entries from a registry containing a large number of indexed items, where the selection outcome determines winners or selected entries.

In a multi-party lottery application, the collection to be randomized may comprise a set of indices corresponding to lottery participants or registry entries. Each index in the set may correspond to a participant identifier, a ticket number, or a registry entry identifier. The indices may be encoded as curve points in the prime-order group using a deterministic encoding function. The encoding function may map each index to a corresponding curve point via a hashing-to-curve construction or a deterministic pre-encoding. The set of curve points corresponding to the indices may be publicly known to all participants before the lottery process begins.

The participant set for a multi-party lottery application may comprise multiple parties with an interest in the integrity of the selection process. Each participant may generate a private key off-chain and may register public credentials with an on-chain contract during a key setup phase. The participants may include lottery operators, auditors, regulatory representatives, or lottery entrants. The distribution of shuffling authority among multiple participants may provide that no single party may control or predict the selection outcome.

During a state initialization phase for a multi-party lottery application, the set of indices may be placed on-chain in encrypted form. Each index may be encrypted under an aggregated public key derived from the individual public keys of the participants. Because the encoding rule mapping indices to curve points is publicly known, the initial encrypted state may be computed deterministically from the encoding rule and a public seed. Any verifier may recompute the initial encrypted state independently, and the on-chain contract may verify the correctness of the initial encrypted state by recomputation.

The participants may jointly shuffle the indices through sequential shuffling operations. Each participant may acquire the current encrypted index data from the on-chain contract, apply a random permutation to the encrypted indices, apply re-encryption to the permuted data to produce updated encrypted data, and generate a zero-knowledge proof demonstrating that the shuffling operation was performed correctly. The shuffling operations may randomize the ordering of the encrypted indices such that the correspondence between original index positions and shuffled positions is obscured.

After n valid shuffling turns by n participants, the on-chain contract may hold a uniformly permuted and jointly re-randomized vector of ciphertexts representing the shuffled indices. The joint permutation may represent the composition of the individual permutations applied by each participant. The joint permutation may be unknown to all parties due to the composition of the per-step zero-knowledge property.

Following the shuffling phase, the first index or the first k indices in the post-shuffle vector may be revealed publicly to determine the winners. The value k may correspond to the number of winners to be selected in the lottery or selection application. For a single-winner lottery, k may equal 1, and the first index in the post-shuffle vector may determine the winner. For a multi-winner lottery or selection application, k may be greater than 1, and the first k indices in the post-shuffle vector may determine the winners.

The participants may perform partial decryption operations to remove encryption layers from the first k ciphertext slots in the shuffled index collection. Each participant may remove the encryption layer corresponding to the encryption applied by that participant during the shuffling process. After all participants have performed partial decryption operations for a slot, the participant who completes the final decryption may post the plaintext index along with a consistency proof. The consistency proof may demonstrate that the revealed index corresponds to the ciphertext that was recorded on-chain after the shuffling process.

The revealed indices for the first k slots may constitute the selected winners. The remaining slots in the shuffled index collection may remain encrypted, and the indices in the remaining slots may not be revealed. The selective revelation of the first k entries may provide that the selected winners are publicly known while the ordering of non-selected indices remains concealed.

The multi-party lottery application may achieve bias-resistance under a 1-of-n honesty assumption across the participants. Under the 1-of-n honesty assumption, the joint permutation resulting from sequential shuffling operations by n participants may be computationally indistinguishable from a uniformly random permutation if at least one participant of the n participants is honest. The contribution of an honest participant may prevent other participants from predicting or biasing the final permutation of the index collection. No single party may pre-determine the winners, as the permutation and re-randomization values contributed by each honest participant may randomize the index collection such that other parties cannot predict or control which indices appear in the first k positions.

The multi-party lottery application may operate without reliance on a single-key trust assumption. Verifiable Random Function (VRF) based lottery approaches may rely on a single key-holder or oracle committee to generate random values for the selection process. The party holding the secret key in a VRF-based approach may have the ability to compute multiple outputs for different inputs and select an input that produces a favorable selection outcome. The trustless zero-knowledge randomization and distribution system may remove the single-key trust assumption by distributing the randomization authority among multiple participants. Each participant may contribute randomness to the joint permutation through the shuffling operation performed by that participant, and no single participant may hold a key that provides unilateral control over the selection outcome.

The zero-knowledge proofs verified on-chain may provide cryptographic assurance that each shuffling operation was performed correctly, without revealing the specific permutations applied by each participant. Participants and external observers may verify that the index collection was shuffled correctly based on the cryptographic proofs, without gaining information about the specific permutation applied by any participant. The privacy of shuffle methods may be maintained throughout the shuffling process, preventing participants from gaining information about the index ordering that could be used to predict or influence the selection outcome.

In some implementations, the multi-party lottery application may support large registries containing a large number of indexed items. The system may accommodate registries with hundreds or thousands of entries through the use of wider bitmap implementations or through batched processing of index subsets. For registries exceeding the practical maximum collection size for a single shuffle operation, the indices may be partitioned into subsets, with each subset undergoing a separate shuffling process. The winners may be determined by combining the results of the subset shuffling operations according to a predefined selection rule.

The on-chain contract may gate partial-decryption transactions for winner reveals on a predicate. The predicate may comprise a wall-clock time condition specifying that winners may be revealed after a designated lottery closing time. The predicate may also comprise a block number condition or an external oracle signal indicating that the lottery entry period has concluded. The on-chain contract may compare the current block timestamp or an external time reference against the predicate condition and may accept partial-decryption transactions when the condition is satisfied. The predicate-gated reveal mechanism may enforce that winner selection remains concealed until the designated reveal time.

The multi-party lottery application may operate without reliance on a centralized random oracle for winner selection. No centralized random oracle may be used to generate or provide random values for the selection process. Each participant may generate randomness locally, and the randomness contribution of each participant may be validated by zero-knowledge proofs submitted to the on-chain contract. The elimination of reliance on a centralized random oracle may remove a potential point of manipulation or failure from the lottery application.

### Computing System

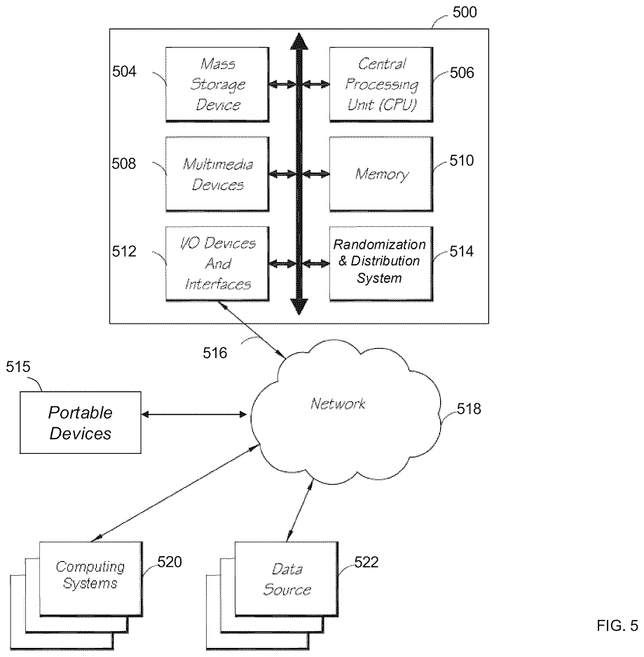

In some implementations, the systems, computer clients and/or servers described above take the form of a computing system 500 shown in FIG. 5, which is a block diagram of some implementations of a computing system (which can be a fixed system or mobile device) that is in communication with one or more computing systems 520 and/or one or more data sources 522 via one or more networks 518. The computing system 500 may be used to implement one or more of the systems and methods described herein. In addition, in some implementations, the computing system 500 may be configured to process image files. While FIG. 5 illustrates some implementations of a computing system 500, it is recognized that the functionality provided for in the components and modules of computing system 500 may be combined into fewer components and modules or further separated into additional components and modules.

In some implementations, the system 500 comprises a system 514 that carries out the functions, methods, and/or processes described herein. The randomization and distribution system 514 may be executed on the computing system 500 by a central processing unit 506 discussed further below.

In some implementations, the processes, systems, and methods illustrated above may be embodied in part or in whole in software that is running on a computing device. The functionality provided for in the components and modules of the computing device may comprise one or more components and/or modules. For example, the computing device may comprise multiple central processing units (CPUs) and a mass storage device, such as may be implemented in an array of servers.

In general, the word “module,” as used herein, refers to logic embodied in hardware or firmware, or to a collection of software instructions, possibly having entry and exit points, written in a programming language, such as, for example, Java, C or C++, or the like. A software module may be compiled and linked into an executable program, installed in a dynamic link library, or may be written in an interpreted programming language such as, for example, BASIC, Perl, Lua, or Python. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules but may be represented in hardware or firmware. Generally, the modules described herein refer to logical modules that may be combined with other modules or divided into sub-modules despite their physical organization or storage.

In some implementations, the computing system 500 also comprises a mainframe computer suitable for controlling and/or communicating with large databases, performing high volume transaction processing, and generating reports from large databases. The computing system 500 also comprises a central processing unit (“CPU”) 506, which may comprise a microprocessor. The computing system 500 further comprises a memory 510, such as random-access memory (“RAM”) for temporary storage of information and/or a read only memory (“ROM”) for permanent storage of information, and a mass storage device 504, such as a hard drive, diskette, or optical media storage device. Typically, the modules of the computing system 500 are connected to the computer using a standards-based bus system. In different implementations, the standards-based bus system could be Peripheral Component Interconnect (PCI), Microchannel, SCSI, Industrial Standard Architecture (ISA) and Extended ISA (EISA) architectures, for example.

The computing system 500 comprises one or more commonly available input/output (I/O) devices and interfaces 512, such as a keyboard, mouse, touchpad, and printer. In some implementations, the I/O devices and interfaces 512 comprise one or more display devices, such as a monitor, that allows the visual presentation of data to a user. More particularly, a display device provides for the presentation of GUIs, application software data, and multimedia presentations, for example. In the implementation of FIG. 5, the I/O devices and interfaces 512 also provide a communications interface to various external devices. The computing system 500 may also comprise one or more multimedia devices 508, such as speakers, video cards, graphics accelerators, and microphones, for example.

The computing system 500 may run on a variety of computing devices, such as, for example, a server, a Windows server, a Structure Query Language server, a Unix server, a personal computer, a mainframe computer, a laptop computer, a cell phone, a personal digital assistant, a kiosk, an audio player, and so forth. The computing system 500 is generally controlled and coordinated by operating system software, such as z/OS, Windows 95, Windows 18, Windows NT, Windows 2000, Windows XP, Windows Vista, Linux, BSD, SunOS, Solaris, or other compatible operating systems. In Macintosh systems, the operating system may be any available operating system, such as MAC OS X. In other implementations, the computing system 500 may be controlled by a proprietary operating system. Operating systems control and schedule computer processes for execution, perform memory management, provide file system, networking, and I/O services, and provide a user interface, such as a graphical user interface (“GUI”), among other things.

In the implementation of FIG. 5, the computing system 500 is coupled to a network 518, such as a LAN, WAN, or the Internet, for example, via a wired, wireless, or combination of wired and wireless, communication link 516. The network 518 communicates with various computing devices and/or other electronic devices via wired or wireless communication links. In the implementation of FIG. 5, the network 518 is communicating with one or more computing systems 520 and/or one or more data sources 522.

Access to the analysis module 514 of the computer system 500 by computing systems 520 and/or by data sources 522 may be through a web-enabled user access point such as the computing systems' 520 or data source's 522 personal computer, cellular phone, laptop, or another device capable of connecting to the network 518. The connections may be a direct physical connection, a virtual connection, a physical network connection (for example, using a telephone line or the like) and/or a wireless network connection. Other connection types are also possible. Such a device may have a browser module is implemented as a module that uses text, graphics, audio, video, and other media to present data and to allow interaction with data via the network 518.

The browser module or other output module may be implemented as a combination of an all-points addressable display such as a cathode-ray tube (CRT), a liquid crystal display (LCD), a plasma display, or other types and/or combinations of displays. In addition, the browser module or other output module may be implemented to communicate with input devices 512 and may also comprise software with the appropriate interfaces which allow a user to access data through the use of stylized screen elements such as, for example, menus, windows, dialog boxes, toolbars, and controls (for example, radio buttons, check boxes, sliding scales, and so forth). Furthermore, the browser module or other output module may communicate with a set of input and output devices to receive signals from the user.

The input device(s) may comprise a keyboard, roller ball, pen and stylus, mouse, trackball, voice recognition system, or pre-designated switches or buttons. The output device(s) may comprise a speaker, a display screen, a printer, or a voice synthesizer. In addition, a touch screen may act as a hybrid input/output device. In some implementations, a user may interact with the system more directly such as through a system terminal connected without communications over the Internet, a WAN, or LAN, or similar network.

In some implementations, the system 500 may comprise a physical or logical connection established between a remote microprocessor and a mainframe host computer for the express purpose of uploading, downloading, or viewing interactive data and databases on-line in real time. The remote microprocessor may be operated by an entity operating the computer system 500, including the client server systems or the main server system, an/or may be operated by one or more of the data sources 522 and/or one or more of the computing systems. In some implementations, terminal emulation software may be used on the microprocessor for participating in the micro-mainframe link.

In some implementations, computing systems 520 who are internal to an entity operating the computer system 500 may access the analysis module 514 internally as an application or process run by the CPU 506.

In one embodiment, a user access point comprises a personal computer, a laptop computer, a cellular phone, a GPS system, a mobile device, a portable computing device, a server, a computer workstation, a local area network of individual computers, an interactive kiosk, a personal digital assistant, an interactive wireless communications device, a handheld computer, an embedded computing device, or the like.

In addition to the systems that are illustrated in FIG. 5, the network 518 may communicate with other data sources or other computing devices. The computing system 500 may also comprise one or more internal and/or external data sources. In some implementations, one or more of the data repositories and the data sources may be implemented using a relational database, such as DB2, Sybase, Oracle, CodeBase and Microsoft® SQL Server as well as other types of databases such as, for example, a flat file database, an entity-relationship database, and object-oriented database, and/or a record-based database.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terms “about,” “approximately,” and “substantially,” as used herein in reference to a measurable numerical value or range, are intended to encompass the range of values that would be reported by a person of ordinary skill in the art using standard experimental and measurement techniques, accounting for the coefficient of variation or standard error inherent in such measurements.

In another aspect, and particularly where a deviation may exceed the aforementioned numerical range, these terms further encompass any value that performs substantially the same function in substantially the same way to achieve substantially the same result as the stated value. For example, a value is considered to be “about” a recited limit if the resulting composition or method retains the intended technical effect of the implementation described, as would be recognized by one of ordinary skill in the art.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A system for trustless randomization and distribution on a distributed ledger, comprising:
one or more on-chain components comprising a smart contract deployed on a blockchain platform, the smart contract configured to:
store one or more references to a public key;
enforce a deterministic turn order for shuffling operations to be completed by a plurality of participants; and
verify one or more zero-knowledge proofs generated by the plurality of participants;
one or more off-chain components executing on computing devices of the plurality of participants, wherein the one or more off-chain components are configured to:
generate a private key on a computing device of one participant of the plurality of participants;
derive the public key from the private key;
register the public key with the smart contract;
perform a shuffling operation comprising:
acquiring encrypted data from the smart contract;
applying a random permutation to the encrypted data;
applying re-encryption to the permuted data to produce updated encrypted data; and
generating a zero-knowledge proof demonstrating that the updated encrypted data represents a valid permutation and re-encryption of the acquired encrypted data; and
submit the updated encrypted data and the zero-knowledge proof to the smart contract, wherein the smart contract verifies the zero-knowledge proof and updates stored data references upon successful verification.

2. The system of claim 1, wherein the smart contract is further configured to gate partial-decryption transactions on a predicate comprising at least one of a game-state phase condition, a wall-clock time condition, or an external oracle signal.

3. The system of claim 1, wherein the system is further configured to propagate partially decrypted ciphertext or fully decrypted plaintext to a destination ledger via an aggregated signature from a validator set of the blockchain platform.

4. The system of claim 1, wherein the smart contract is further configured to compute an aggregated public key from individual public keys of the plurality of participants, and wherein the encrypted data is encrypted under the aggregated public key.

5. The system of claim 1, wherein the shuffling operation is performed sequentially by each participant of the plurality of participants such that the updated encrypted data reflects combined randomness contributions from the plurality of participants.

6. The system of claim 1, wherein the zero-knowledge proof demonstrates that the shuffling operation applied a valid permutation to the encrypted data without revealing the permutation applied or encryption keys used.

7. The system of claim 1, wherein the one or more off-chain components are further configured to perform partial decryption operations, wherein each participant of the plurality of participants removes an encryption layer corresponding to encryption applied by that participant during the shuffling operation.

8. The system of claim 7, wherein the partial decryption operations are performed sequentially by the plurality of participants, and wherein a last participant in a decryption sequence obtains plaintext data.

9. The system of claim 8, wherein when the plaintext data is to be publicly revealed, the last participant submits the plaintext data along with a consistency proof demonstrating that the plaintext data corresponds to ciphertext previously recorded by the smart contract.

10. The system of claim 1, further comprising an initialization phase wherein a dataset is placed on-chain in encrypted form, and wherein a validity proof is generated to demonstrate that the dataset was created according to protocol parameters.

11. The system of claim 1, wherein the smart contract is configured to enforce a per-turn timeout mechanism and to forfeit a security deposit of a participant that fails to act within a timeout period.

12. The system of claim 1, wherein the system is configured for a gaming application in which data items are to remain hidden from specific participants until designated revelation times.

13. A method for trustless randomization and distribution on a distributed ledger, comprising:
generating, by one or more off-chain components executing on a computing device of one participant of a plurality of participants, a private key;
deriving a public key from the private key;
registering the public key with a smart contract deployed on a blockchain platform, wherein the smart contract stores one or more references to the public key;
performing, by each participant of the plurality of participants in a deterministic turn order enforced by the smart contract, a shuffling operation comprising:
acquiring encrypted data from the smart contract;
applying a random permutation to the encrypted data;
applying re-encryption to the permuted data to produce updated encrypted data; and
generating a zero-knowledge proof demonstrating that the updated encrypted data represents a valid permutation and re-encryption of the acquired encrypted data;
submitting the updated encrypted data and the zero-knowledge proof to the smart contract;
verifying, by the smart contract, the zero-knowledge proof; and
updating, by the smart contract, stored data references upon successful verification of the zero-knowledge proof.

14. The method of claim 13, further comprising computing, by the smart contract, an aggregated public key from individual public keys of the plurality of participants, wherein the encrypted data is encrypted under the aggregated public key.

15. The method of claim 13, further comprising:
performing partial decryption operations off-chain, wherein each participant of the plurality of participants removes an encryption layer from a data item in sequence; and
obtaining, by a final participant in a decryption sequence, plaintext corresponding to the data item.

16. The method of claim 15, wherein the final participant is a designated recipient of the plaintext, and wherein the final participant retains the plaintext without disclosing the plaintext to other participants.

17. The method of claim 16, further comprising:
generating, by the final participant, a consistency proof demonstrating that the plaintext data corresponds to ciphertext recorded on-chain; and
submitting the plaintext data and the consistency proof to the smart contract for verification when the plaintext data is to be publicly revealed.

18. The method of claim 13, further comprising generating a validity proof demonstrating that the dataset contains valid data items and that no invalid items were inserted.

19. The method of claim 13, wherein the zero-knowledge proof demonstrates that the updated encrypted data represents a valid permutation and re-encryption of the current encrypted data without revealing the permutation applied.

20. The method of claim 13, wherein the random permutation is generated using local entropy sources on a computing device of the participant performing the shuffling operation.
